(19) United States
(12) Patent Application Publication
(10) Pub. No.: US 2016/0323736 A1
(43) Pub. Date: Nov. 3, 2016

(54) SECURE BROADCAST SYSTEMS AND METHODS FOR INTERNET OF THINGS DEVICES

(71) Applicant: MELROK, LLC, Reno, NV (US)

(72) Inventors: Paul W. Donahue, Newport Coast, CA (US); Michel Roger Kamel, Buena Park, CA (US); Shad L. Nygren, Fallon, NV (US)

(21) Appl. No.: 15/099,300

(22) Filed: Apr. 14, 2016

Related U.S. Application Data
(60) Provisional application No. 62/148,065, filed on Apr. 15, 2015.

(51) Int. Cl. H04W 12/04; H04L 9/08; H04L 29/06; H04H 60/23; H04L 29/08

(52) U.S. Cl. CPC H04W 12/04; H04H 60/23; H04L 67/12; H04L 63/0428; H04L 9/0891

(57) ABSTRACT

An encryption key is used to decode messages sent to control devices, such as devices connected by the Internet of Things. For security, at least a portion of the encryption key is send to a receiving device via a first communication technology and a remaining portion of the encryption key is sent to the receiving device via a second communication technology different or disparate from the first communication technology.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND

Emergency Alert System (EAS) equipment is in place in television, radio, and cable facilities nationwide and has been used for local weather emergencies for decades. The EAS currently is comprised of analog and digital radio broadcast stations, including AM, FM, and low-power FM stations; analog and digital television (DTV) broadcast stations, including Class A television and low-power TV stations; analog, digital, and wireless cable systems; Direct Broadcast Satellite (DBS) systems, Satellite Digital Audio Radio Systems (SDARS); and other entities.

The present-day EAS is a hierarchical analog message distribution system in which a message originator at the local, state, or national level relays EAS messages from station to station in a problematic “daisy chain” manner. This existing approach to distribution of emergency alerts relies upon retransmission of an alert message from primary broadcasters to secondary broadcasters and then to tertiary broadcasters. This retransmission process introduces significant delay. Moreover, this process generally requires human intervention and in many instances has been found to be a point of breakdown resulting in failure in the distribution of alerts. In many cases the requirement for retransmission is voluntary, and local broadcasters may decide not to transmit an alert due to financial considerations as they may be required to sacrifice commercial time to play an alert.

An additional drawback of existing systems for alert distribution is the inability to target an individual alert to those persons for which that alert is meaningful and not distribute it to those for which it is not relevant. For example, residents of neighborhoods close to the site of an accidental toxic gas release or downwind of the release would need to receive an alert of the event, while residents of areas separated by distance or topography from the point of release may not need to receive the alert.

In the field of energy management, demand response and automated demand response programs and systems have been created to facilitate the reduction or increase in user or demand side loads during periods of energy generation shortage, excesses, or disruptions in distribution. These systems typically rely on a signal that is sent to a subset of users enrolled in a specific program. Despite significant efforts over the past decade, only a relatively small proportion of commercial and industrial customers are participating in these programs. Many of these systems do not provide adequate information about cause of energy inefficiencies nor do they provide effective energy decision-making information. Moreover, the majority of these participants rely on manual action to initiate demand reduction or increase measures. This human involvement limits the timeliness and extent of reduction levels achieved.

### BRIEF DESCRIPTION OF THE DRAWINGS

FIG. 1 illustrates a system to wirelessly distribute addressable energy information data, according to certain embodiments.

FIG. 2 illustrates an exemplary data structure and information for RF transmission of energy information, according to certain embodiments.

FIG. 3 illustrates a system to manage energy, according to certain embodiments.

FIG. 4 illustrates a system to transmit energy control or information signals to energy control devices, according to certain embodiments.

FIG. 5 illustrates an exemplary addressable energy demand response controller, according to certain embodiments.

FIG. 6 illustrates types of encryption, according to certain embodiments.

FIG. 7 illustrates symmetric encryption, according to certain embodiments.

FIG. 8 illustrates asymmetric encryption, according to certain embodiments.

FIG. 9 illustrates symmetric encryption using disparate communication media, according to certain embodiments.

FIG. 10 illustrates another embodiment of symmetric encryption using disparate communication media.

FIG. 11 illustrates encryption with subkeys, according to certain embodiments.

FIG. 12 illustrates another embodiment of encryption with subkeys.

FIG. 13 illustrates encryption with public and private keys over disparate communication media, according to certain embodiments.

FIG. 14 illustrates another embodiment of encryption with public and private keys over disparate communication media.

FIG. 15 illustrates the use of the asymmetric keys of FIG. 14 to communicate, according to certain embodiments.

FIG. 16 illustrates password protection using disparate communication media, according to certain embodiments.

FIGS. 17A-17C illustrate cryptographic key distribution and encrypted data transmission, according to certain embodiments.

FIGS. 18A through 18E illustrate an exemplary key revocation/renewal flow, according to certain embodiments.

FIG. 19A illustrates a system-level private-key-distribution hierarchy, according to certain embodiments.

FIG. 19B illustrates an embodiment of private key distribution flow from Device 1 to Device 2.

FIG. 20A illustrates a system-level public-key-distribution hierarchy, according to certain embodiments.

FIG. 20B illustrates an embodiment of public key distribution flow.

FIG. 21A illustrates a system-level public-key-distribution hierarchy, according to certain embodiments.

FIG. 21B illustrates exemplary communications between devices that are protected by asymmetric-key algorithm, according to certain embodiments.

FIG. 22 illustrates a communication sequence between devices, according to certain embodiments.

### SUMMARY

In an embodiment, an encryption code or key is used to decode messages sent to control devices, such as devices connected by the Internet of Things. For security, at least a portion of the encryption key is send to a receiving device via a first communication technology and a remaining portion of the encryption key is sent to the receiving device via a second communication technology different or disparate from the first communication technology.

In an embodiment, the first communication technology can comprise one or more of AM, FM, or TV cellular, satellite, Wi-Fi® or WiMax® broadcast subcarriers; AM, FM, or TV cellular, satellite, Wi-Fi®, WiMax® digital broadcast subcarriers; and the like. In an embodiment, the second communication technology can comprise one or more of wired or wireless WiFi®, Zigbee®, Ethernet® or other networking protocols; cellular communication; the Internet; local area networks; wide area networks; metropolitan area networks, mesh networks, and the like.

The receiving device combines the two portions that were sent using disparate communication technologies to provide a complete or whole encryption key. The ratio of the portion of the encryption key sent via the first communication technology to the remaining portion send via the second communication technology can vary. For example, the ratio can be 50%/50%; 100%/0%; 0%/100%; 25%/75%; 67%/33%; and the like.

Embodiments described herein use one or more of temporal diversity, geographic diversity, frequency modulation schemes of an FM band subcarrier, apportionment of encryption keys over disparate communication media to provide secure communication with control of at least energy devices, Internet of Things (IoT) devices, and distributed energy resources (DER).

In some implementations, the present disclosure relates to a device to communicate encrypted messages over a first communication medium. The device comprises a receiver configured to receive a first portion of an encryption key transmitted within a first wideband digital subcarrier operating within a licensed frequency spectral mask of a terrestrial wireless VHF FM Broadcast radio station, where the receiver is further configured to receive a second portion of the encryption key transmitted within a second wideband digital subcarrier operating within the licensed frequency spectral mask of the terrestrial wireless VHF FM Broadcast radio station, a control module configured to use the first and second portions to form the encryption key, a communication port configured to receive a message over the first communication medium, where the received message was encrypted using the encryption key.

The control module is further configured to decrypt the received message using the encryption key, create a response based at least in part on the decrypted message, and encrypt the response using the encryption key and the communication port is further configured to transmit the encrypted response over the first communication medium, where the first communication medium is different from the first and second wideband digital subcarriers operating within the licensed frequency spectral mask of the terrestrial wireless VHF FM Broadcast radio station.

In an embodiment, the first communication medium comprises one or more of a wired networking protocol, a wireless networking protocol, cellular communications, the Internet, a local area network, and a wide area network. In another embodiment, each of the first and second wideband digital subcarriers of the licensed terrestrial wireless VHF FM Broadcast radio station has a data throughput of at least 12 kilobits per second. In a further embodiment, the encryption key is allocated by one or more of type of apparatus, region, time of day, alert priority level, originator, message type, customer identification, location data, grid location data, tariffs affected, apparatus class, and apparatus subclass.

In an embodiment, the receiver is further configured to receive a third portion of the encryption key transmitted within a third wideband digital subcarrier operating within the licensed frequency spectral mask of the terrestrial wireless VHF FM Broadcast radio station. In another embodiment, the control module is further configured to use at least two of the first, second, and third portions to form the encryption key.

In an embodiment, the encryption key is updated once a minute. In another embodiment, updating the encryption key comprises varying a ratio of the first portion of the encryption key to the second portion of the encryption key. In a further embodiment, the decrypted message comprises a command to change an energy consumption that includes changing one or more of an energy source, an amount of energy consumed, an operational point, an operational schedule, and an operational parameter. In a yet further embodiment, the device further comprises a motor, where the control module is further configured to send control signals to the motor to change the energy consumption of the motor, and where the encrypted response comprises encrypted data associated with the change in the energy consumption of the motor.

In some implementations, the present disclosure relates to a method to communicate encrypted messages over a first communication medium. The method comprises receiving a first portion of an encryption key transmitted within a first wideband digital subcarrier operating within a licensed frequency spectral mask of a terrestrial wireless VHF FM Broadcast radio station, receiving a second portion of the encryption key transmitted within a second wideband digital subcarrier operating within the licensed frequency spectral mask of the terrestrial wireless VHF FM Broadcast radio station, and using the first and second portions to form the encryption key.

The method further comprises receiving a message over the first communication medium, where the received message was encrypted using the encryption key, decrypting the received message using the encryption key, creating a response based at least in part on the decrypted message, encrypting the response using the encryption key, and transmitting the encrypted response over the first communication medium, where the first communication medium is different from the first and second wideband digital subcarriers operating within the licensed frequency spectral mask of the terrestrial wireless VHF FM Broadcast radio station.

In an embodiment, the method further comprises receiving a third portion of the encryption key transmitted within a third wideband digital subcarrier operating within the licensed frequency spectral mask of the terrestrial wireless VHF FM Broadcast radio station. In another embodiment, the method further comprises using at least two of the first, second, and third portions to form the encryption key.

In an embodiment, the method further comprises updating the encryption key once a minute. In another embodiment, updating the encryption key comprises varying a ratio of the first portion of the encryption key to the second portion of the encryption key. In a further embodiment, the method further comprises changing an energy consumption based at least in part on the decrypted message, where changing the energy consumption comprises changing one or more of an energy source, an amount of energy consumed, an operational point, an operational schedule, and an operational parameter. In a yet further embodiment, the method further comprises sending control signals to a device to change the energy consumption of the device, wherein the encrypted response comprises encrypted data associated with the change in the energy consumption of the device.

### DETAILED DESCRIPTION

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

A decision support system for energy use demand management is provided. The system includes a one way broadcast communications capability for transmitting energy management signals to a population of energy consumers, coupled with an independent capability to return energy consumption data that can be correlated with the energy management signals. The system utilizes an FM subcarrier having sufficient bandwidth to selectively and rapidly address a large population of devices.

Past approaches to utilize broadcast signals, such as RDS based systems, have been constrained by limited available bandwidth and due to this limited capacity have been unable to employ more sophisticated addressing schemes that allow more granular and more advanced demand management approaches. The advent of a higher bandwidth system utilizing the addressing capabilities described herein allows the employment of probabilistic management approaches that overcome the drawbacks of conventional deterministic management methods.

Broadcast station subcarrier signals can be used for signaling remotely located and widely dispersed energy controllers including time shifting, on/off, frequency shifting variable speed motor controllers, dimmable light ballasts, and/or energy storage demand side devices that are located throughout the coverage area of a broadcast transmitter and within the service area of an electric or energy utility. Such remotely located and dispersed devices can be controlled by imparting information onto such broadcast transmission subcarriers, including turning on or off one or more frequency tones or subcarriers, imparting a modulation scheme on the main carrier, or imparting analog or digital modulation on the subcarriers of a broadcast station's main earner.

Addressing of individual alerts, information, and device control can be categorized by intended user or group of devices. Addressability can include but is not limited to specific use characteristics such as first responder, local authorities, individuals residing in certain geographic areas, motors, pumps, electric appliances, electric fixtures and to mobile and/or fixed end point receiving devices within a certain GPS defined area, and other parameters.

Filtering of alerts and messages can occur by a variety of means at the endpoint-receiving device. This can take the form of opting-in for desired message categories, opting-out for undesired categories, default settings to define the appropriate types of messages, which should be delivered, or any combination of these approaches.

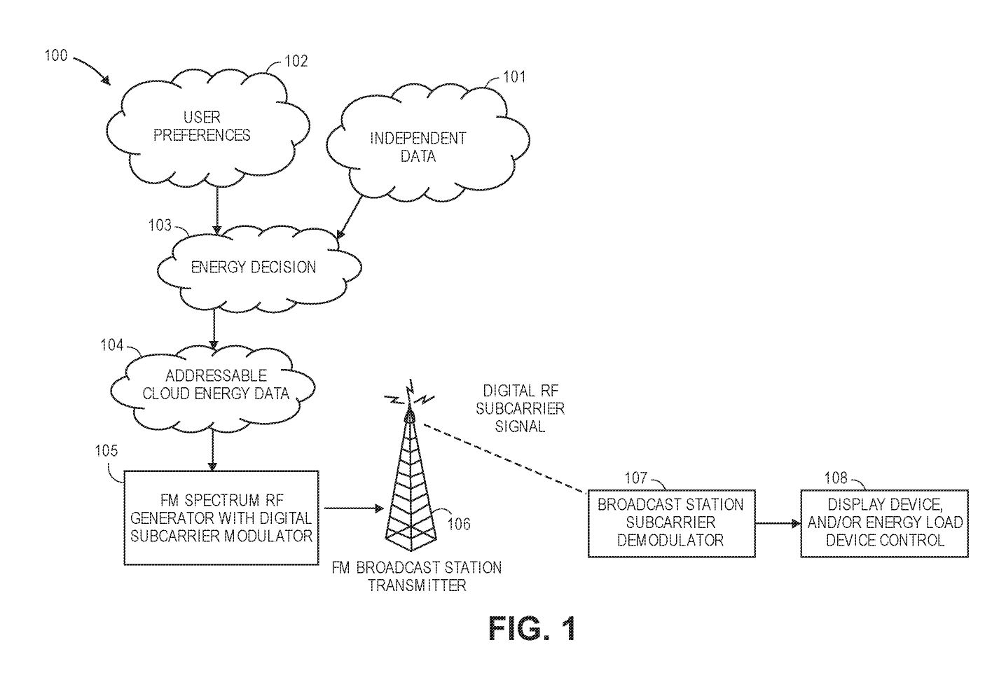

FIG. 1 illustrates a system 100 to wirelessly distribute addressable energy information through a broadcast station subcarrier. In some embodiments, the system 100 utilizes a 1-way wide bandwidth licensed terrestrial very high frequency (VHF) or other broadcast transmission system and is configured to operate in either multicast “one to many” or selective narrowcasting “one to one” energy or “machine to machine” data communications to control devices that are distally located from the transmitter at the local site of energy generating equipment, and/or energy transmission equipment, and/or energy loads.

In other embodiments, the system 100 can be used for “machine to machine” information and device control beyond the field of energy and may include water distribution systems, industrial processes, food processes, personalized media aggregator devices, financial transaction devices, and the like.

Typically systems for measurement of end point device or machine actions and the resultant selective wireless dissemination of energy or other “machine to machine” device information and control information would normally use a two way transmission system where the “end point” device receiving information or device control signals is also configured to transmit “return path” information over the same or another communication link.

The benefits of distributing information and device control signals through use of wide bandwidth high powered 1-way VHF or other broadcast stations include but are not limited to overcoming “Firewall” or other incoming data blocking methods and overcoming information and control signal attenuation that can be caused by intervening geography, intervening structures, intervening concrete, brick, and wallboard walls, intervening steel structures, and intervening foliage. In such instances where the use of the wide bandwidth, high powered, 1-way broadcast of information and device control is warranted for reliable outbound communication and device control, no such communication return path normally exists.

The system 100 configures a 1-way broadcast system to behave like a two way communication system where the “return path” communication is an assembly of one or more independent but correlated data inputs that are automatically, intelligently, and dynamically acted upon

The system 100 comprises independent data 101, user preference data 102, an energy decisions module 103, and addressable energy data 104. The energy decision module 103 receives the independent data 101 and the user preference data 102 and provides energy decisions based at least in part on the received independent data 101 and user preference data 102. In an embodiment, the energy decisions module 103 comprises a cloud-based computing system. In another embodiment, the energy decisions module 103 comprises one or more IDSS “Intelligent Data Support System” or “Knowledge based System” that are either “cloud based” or residing on one or more local or distal servers.

The independent data 101 comprises, but is not limited to energy data, energy information, energy management data, or other data related to energy usage. Examples of independent data are interval meter, submeter, or smartmeter data, natural gas data, occupancy sensor data, CO₂ or oxygen sensor data, HVAC system set point data, lighting level data, power grid parameters, microgrid parameters, utility data, geographic data, schedule data, pricing data, BIM (building information management) data, system specification data, equipment specification data, equipment performance data, events log data, customer data, time series data, target parameters, security keys, confirmation codes, decision metrics, weather data such as predictive or actual weather patterns, predictive or actual cloud cover, predictive or actual rain, predictive or actual wind patterns, and predictive or actual local environmental conditions, solar irradiance data, other data conditions that are independent but relevant to energy use, automated demand response (ADR) signals signaling from utilities that are to be distributed to their service area users or a subset of their service area users, real time or dynamic energy supply and pricing signals, emergency or other non-emergency information, solar or wind generator output, manual confirmation of actions, automated confirmation of actions, and the like that enable the determination of useful versus wasted energy at a given location.

User preference data 102 comprises information received from user interface devices that present users with choices on energy usage, including preferences for comfort level or temperature levels that may be adjusted relative to information about energy costs, preferences for facility occupancy, preferences for energy pricing, preferences for energy curtailment opportunities, control rules, and the like.

The energy decisions module 103 comprises a data base that includes the independent data 101 and/or user preferences data 102, a modeling element that acts upon data 101, 102 to automatically and dynamically derive or determine actions for groups of devices or single devices, distal from the 1-way VHF broadcast transmission site. The energy decisions module 103 outputs the addressable cloud energy data 104 which comprises energy data decisions addressed to remotely-located addressable devices where information is to be disseminated and/or control of such devices is to occur. Examples of the addressable cloud energy data 104 comprise energy machine control, energy load control, energy generation control, energy storage control, machine process control, energy transmission routing control using Web-based and/or “cloud based” analytical algorithms, and the like.

In an embodiment, the energy decisions module 103 combines knowledge of the energy optimization domain with an inference capability to enable the system to diagnose useful versus wasted energy data from the data 101, 102 and provide outputs 104 that behave approximately like a human consultant. The energy decisions module 103 gathers and analyzes the data 101, 102, identifies and diagnoses problems, proposes possible courses of action and evaluates the proposed actions. In an embodiment, these artificial intelligent techniques embedded in intelligent decision support system of the energy decisions module 103 enable these tasks to be performed by a cloud based or local computer.

In an embodiment, the energy decisions module 103 comprises intelligent computing agents and algorithms that perform complex cognitive tasks without human intervention. In an embodiment, the energy decisions module 103 comprises an active dynamic and/or neural network decision support system “DSS” for energy modeling where algorithms may be based on selected cognitive decision-making functions and artificial intelligence or intelligent agents technologies that output individual or groups of device control(s) signals, and/or energy information.

The system 100 further comprises an RF generator 105 and a transmitter 106. The RF generator 105 and the transmitter 106 comprise elements of a wideband digital subcarrier and broadcast transmitting station that are operating within the licensed spectral mask of a licensed terrestrial broadcasting station. In an embodiment, the wideband digital subcarrier has a data throughput of at least 16 kilobit per second. In another embodiment, the wideband digital subcarrier has a data throughput of at least 12 kilobit per second. In an embodiment, the broadcasting station comprises a terrestrial wireless VHF broadcasting station. In another embodiment, the broadcasting station comprises a terrestrial wireless UHF or microwave broadcasting station. In an embodiment, the broadcasting station has a licensed transmitting power of at least 100 watts. In another embodiment, the broadcasting station operates with an antenna that is placed at least 500 feet above average surrounding terrain. In an embodiment, the broadcasting station is an analog broadcasting station that is licensed to operate within FM Broadcast frequencies of approximately 73 to approximately 108 megahertz. In another embodiment, the broadcasting station is a digital broadcasting station that is licensed to operate within FM Broadcast frequencies of approximately 73 to approximately 108 megahertz.

In an embodiment, the RF generator 105 comprises a licensed FM broadcast station spectrum RF generator that is licensed to operate within FM Broadcast frequencies of approximately 73 to approximately 108 megahertz with a digital subcarrier modulator. The energy decision data is sent from the addressable energy data module 104 to the RF generator 105. The RF generator 105 imparts the energy decision data on a subcarrier that modulates the main transmission carrier of a broadcast station. In an embodiment, the broadcast station comprises the transmitter 106.

In some embodiments, the transmitter 106 comprises at least one of an AM medium wave Broadcast transmitter licensed to operate within frequency spectrum of approximately 550 kilohertz to approximately 1.7 megahertz, FM VHF transmitter that is licensed to operate within FM Broadcast frequencies of approximately 73 to approximately 108 megahertz, TV VHF or UHF transmitter that is licensed to operate with frequency spectrum of approximately 50 megahertz to approximately 2100 megahertz, digital VHF, UHF microwave transmitter, radio frequency transmitter, and satellite broadcast radio frequency transmitter (RF) that delivers approximately greater than 10 watts of power from a main carrier of any bandwidth into any type of transmitting antenna.

In an embodiment, the transmitter 106 comprises an FM VHF transmitter and the addressable energy decision data is transmitted within a wideband digital subcarrier operating within the licensed frequency “spectral mask” of a terrestrial wireless VHF broadcasting station. In an embodiment, the wideband digital subcarrier of licensed terrestrial wireless VHF broadcasting station operating within the frequency spectrum of approximately 73 to approximately 108 megahertz with a data throughput of at least 16 kilobit per second. In a further embodiment, terrestrial wireless VHF broadcasting station has a licensed transmitting power of at least 100 watts. In a yet further embodiment, the terrestrial wireless VHF analog broadcasting station operates with an antenna that is placed at least 500 feet above average surrounding terrain.

The system 100 further comprises a demodulator or receiver-controller 107, and an energy load control device 108. The receiver-controller 107 receives the digital RF subcarrier signal transmitted from the transmitter 106, and demodulates the RF signal to extract the addressable energy data information. In an embodiment, the receiver-controller 107 is individually addressed or addressed as a group through the addressable energy data. The receiver-controller 107, in some embodiments, can output information, device control signals or other signals including audible music and information or display information that can include text, visual or audible alerts and alarms, or other methods for conveying information or control signals to end point users or devices 108.

In one embodiment, more than one transmitter 106 can be used to send the same or different data to the same receiver-controller 107. This can be to increase the reliability of the transmission, to reach devices that are in the shadow of the broadcast of one of the transmitters, to increase the amount of data delivered to receiver-controller 107, to provide for a redundant transmitter in case of failure of one or more transmitters 106, or to improve the security of the data delivered to receiver-controller 107.

The demodulated addressable energy data is sent to the energy load control device 108 where it is displayed or used for energy control. In an embodiment, the energy load control devices 108 is individually addressed or addressed as a group through the addressable energy data. When used for energy control, the energy load control devices 108 generate control output signals to control the energy usage of energy using devices. Examples of control output signals are, but not limited to pumps ON/OFF, vacuum fluorescent ballast set points, fans ON/OFF, boilers ON/OFF, temperature set, reheat coils ON/OFF, lights ON/OFF or dim, fountains ON/OFF, whirlpool ON/OFF, pool pumps ON/OFF, equipment ON/OFF, selected thermostat or HVAC chilled water or boiler set points, selected Variable Frequency AC Motor Drivers (VFD) settings, electric vehicle chargers ON/OFF, power inverter ON/OFF, electric storage chargers ON/OFF, power inverter settings, energy storage charge controller settings, Automatic Transfer Switch Mode (ON/OFF), Variable Air Volume (VAV) controller settings, blink lights or sound alerts, other control of energy generators, transmission systems, or energy load devices, and the like.

In an embodiment, receiver-controller 107 sends energy data to one or more load control device 108. In another embodiment, load control device 108 receives energy data from one or more receiver-controller 107.

In an embodiment, the energy decisions module 103 can also be configured to function as a cooperative IDSS that modifies, completes, or refines energy decision output control signals and information that are passed along as data information and/or device control signaling information 104 for addressable transmission by the modulator 105 and the transmitter 106 to distal wireless receiving devices 107 for display of information or device control by devices 108. The energy decisions module 103 correlates and analyzes the independent data inputs 101 and user preferences 102 send the results of the analysis through the transmission system 105, 106 for validation. In this configuration, the system 100 improves, completes, and refines the control signals from the energy decision module 103. The process of data collection, analysis by modeling algorithm, establishment of addressable information and device control, and transmission and reception of such information and controls feedback to the energy decision module as independent data 101 until a consolidated solution is arrived at for any of a variety of energy use conditions and variables.

In an embodiment, the energy decision module 103 establishes an energy use rule base that acts upon incoming data 101, 102. The use of data feedback from the independent but correlated data 101 can be used to validate and check for consistency of the outputs of addressable energy data 104 from the energy decision module 103.

An embodiment of the energy decision module 103 comprises an energy “DSS” and/or “IDSS” system and can be configured as one or more of the following: a data-driven DSS or data-oriented DSS that analyzes independent external energy and environmental data 101 and user preferences 102 using analytic techniques such as one or more of Regression analysis, Linear regression analysis, Discrete choice modeling, Logistic regression analysis, Time series modeling, Multivariate adaptive regression spline modeling, Machine learning, Neural networks, Support vector machines, k-nearest neighbors, and/or Geospatial predictive modeling, to output specific energy information and control signals for addressing individual or group(s) of energy devices 104 to the modulator 105 for transmission by the transmitter 106

In some embodiments, the independent data 101 and the user preference data 102 acted upon by IDSS agents within the energy decision module 103 may be used to provide localized control signaling or information outputs that are either wireless such as 802.11 based or wired using local transmission techniques such as PLC “power line carrier” that are IP or other format based for device communication and control.

In certain embodiments, the outputs of the energy decision module 103 comprise data from which energy DSS “decisions” and/or IDSS “intelligent decisions” are generated and passed along as addressable energy data 104 for assignment to individual or group(s) of receiving devices 107, 108 and are transmitted the transmission system 105, 106. In one embodiment use of localized wireless or wired communication such as from 802.11 or wired PLC power line carrier may be used to avoid congestion on wide area coverage broadcast stations.

In other embodiments, the energy decision module 103 employs Big Data processing techniques such as Hadoop® or ApacheSpark® for processing Big Data from energy and independent data sources.

Individual devices are associated with individual loads or co-located groups of loads that may be connected via local wired or wireless links. The receiver-controller unit 107 associated with each individual load can identify those broadcast transmissions that are intended for its companion load(s). An example of the elements used in the addressing of individual devices or groups of devices is shown in Table 1.

TABLE 1
Device Broadcast Addressing Scheme

```
Device ID
Customer ID
Geographic Location ID
    Region, district,
Grid Location ID
    Substation, Feeder, Transformer, Service Address
Device Class
    Central AC unit, Package unit, Water heater, Thermostat,
    Lighting array, Pool pump, Irrigation pump, generation, storage,
Device Subclass Pumps >10 HP, generation > solar, storage >
thermal,
Tariff
    C&I TOU, Residential
Random group assignment
Special status codes
```

The device broadcast addressing may comprise one or more of a device ID, a customer ID, a geographic location ID, a grid location ID, a device class, a device subclass, tariff, group assignment, special status codes, and the like. A device ID comprises an identifier associated with an addressable device while a customer ID identifies a specific customer or a group of customers. Examples of the geographic location ID are, but not limited to a regional ID, a district ID, and the like. A grid location ID, for example, may identify the substation, the feeder line, the transformer or the service address. Different device classes may be identified in the address, which identify the device, for example, as a central air conditioning unit, a pump, a water heater, a thermostat, a lighting array, a pool pump, an irrigation pump, other electrical device consuming energy, a power generation device, or a power storage device. Device subclasses identify the energy rating of the identified device.

Examples of different energy or water rate tariffs identified in the device address are not limited to commercial and industrial users, agriculture, small to medium enterprises (SME) and residential tariffs that include energy use tariffs such as Time of Use (TOU) energy tariffs, real time pricing (RTP) energy tariffs, critical peak pricing (CPP) energy tariffs, cost per acre foot, cost per Therm, cost per volume of natural gas, and the like. For example, there are many rate structures that number in the 100s or more in the US alone. These rate structures are enabled through the new digital smart meter, digital smart gas meters, digital water meters and these tariffs that are so enabled comprise the new reality of energy and water pricing in the US and around the world where electric energy and water that was once “cheap and reliable with flat pricing” is becoming “costly, variable penalty based in price, and unreliable due to the high percentage mandates for diurnal and weather related renewables”. Emerging and existing electric energy and natural gas energy and water pricing tariffs relate to time of energy or water being used, the time of day that the energy or water is consumed (mid-day summer being the highest price due to widespread HVAC system use), amount of energy used in kilowatt/hours, megawatt/hours, or gigawatt/hours, and speed at which energy is used as expressed in kilowatts/time interval, megawatts/time interval, and gigawatts/time interval.

Random group assignments comprise a common address segment for a group of one or more devices. This enables an energy management command to be broadcast to a randomly selected subset of the total population of devices in a given category. So, for example, during the four successive thirty minute intervals of a two hour period four equal size groups of randomly assigned end point devices could be shut down. Examples of special status codes are, but not limited to a code designating devices that are located in facilities known to be unoccupied during school holidays and a code designating locations that are temporarily excluded from demand reduction measures, and the like.

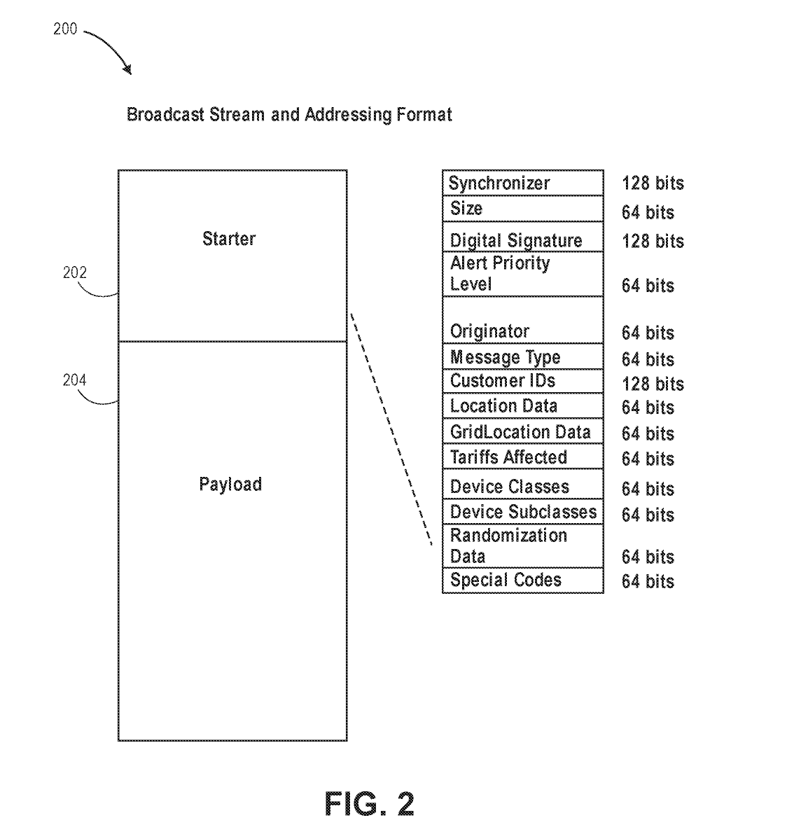

FIG. 2 illustrates an exemplary data format 200 for addressing receiver-controller units in the broadcast stream. The message comprises a starter or header 202 and a payload or message 204. In the illustrated embodiment, the starter comprises a 128 bit synchronizer segment for synchronization with the receiver-controller unit, a 64 bit message size segment indicating the size of the message 204, a 128 bit digital signature identifying the receiver-controller unit, and a 64 bit alert priority segment identify the priority level of an energy alert.

The illustrated starter 202 further comprises a 64 bit originator segment indicating who or what send the message, and a 64 bit message type segment. Examples of message types are a code designating devices that are located in facilities known to be unoccupied during school holidays and a code designating locations that are temporarily excluded from demand reduction measures. The illustrated starter 202 further comprises a 128 bit customer ID segment, a 64 bit location data segment, a 64 bit grid location data segment, and a 64 bit tariff segment. The illustrated starter 202 further comprises a 64 bit device class segment, a 64 bit device subclass segment, a 64 bit randomization data segment, and a 64 bit special code segment. Additional segments could be added and the number of bits for each segment can vary from the example in FIG. 2.

In an embodiment, a digital signature is included to confirm the identity of the sender. In one embodiment, a hash of the signature is sent and compared to the hash of the signature embedded in receiver-controller 107. Receiver-controller 107 compares the hash of the signature to a hash it has in memory confirming to receiver-controller 107 the identity of the sender and the validity of the received data.

In one embodiment, a security key is included in the device broadcast to allow for the decryption of the message. The key can be a symmetric key or a public key used in an asymmetric encryption algorithm.

Logic for identifying messages addressed to an individual load typically involves Boolean operators, such as AND, NAND, OR, NOR, for example, that define the combination of location, device type and other factors that describe the intended message recipients.

Broadcast signals may include demand response alerts and demand response event requests and commands, signals used to manage energy usage, signals used to convey future pricing changes or forecasts, signals used to manage distributed energy resources (DER), signals used to manage distributed generation, signals used to manage distributed storage, signals used to manage demand shed, signals used to manage demand increase, current pricing information or consumer advisories, and other management and status information. By using the addressing capacity, such signals can be targeted to any number of endpoints within the broadcast signal shadow. The number of individual endpoint targets for a given message can range from a single endpoint or consumer to the entire population in the coverage area, which could number in the millions.

With existing demand management systems that employ direct load control, during a peak demand event on a hot summer day all devices connected to residential air conditioning units within a given section of the utility grid might be called upon to cycle off compressors for some portion of each hour during a four hour event time window. This would affect all of the residences in the given section each hour of the window.

In contrast, utilizing the addressing capability described herein, it is possible to call on a more discrete subset of air conditioners to cycle back. For example, a randomly selected group representing twenty percent of the controllable device population could be cycled back during the first hour of the event window, then a second and different twenty five percent of devices cycled back during the second hour, then a third and yet different thirty percent subset of devices cycled back during the third hour, and finally a forth and yet different twenty percent of devices cycled back during the final hour. Moreover, these percentage adjustments could be made differently within each subsection of the grid, and could be made differently for differing classes of device, as for example when all pool pumps were cycled back within the time event but the air conditioning cycling was only employed within certain time periods or certain sectors of the grid, thus lessening the impact of the peak demand event.

An example of the logic using Boolean operators to provide the selective addressing, described in the above example is: Device Class ID <ResidAC> AND GridLocation ID <substationXYZ> AND RandomGroup <1001A>. In other embodiments, other methods of address decoding are used.

The utility of the selective addressing capability described herein is amplified given the ability to monitor actual changes in power consumption occurring within localized sectors of the grid subsequent to broadcast of management signals. Broadcast of signals with selective addressing brings increased granularity of control. This allows finer tuning of demand and lessens the potential for customer discomfort.

The advent of advanced metering infrastructure, included smart meters, interval meters, and sub meters that provide frequent measurement and communication of energy usage, permits the development of analytic algorithms that can determine the sources of energy load consumption and identify sources of unproductive, inefficient, and wasteful energy use and Greenhouse Gas emissions that are related to facility energy usage. Such algorithms also identify system adjustments and remote control actions that can reduce energy costs by avoiding utility peak load or transmission capacity charges and pursuing other energy cost-saving measures.

It is recognized that multiple embodiments can be assembled and utilized from the various components or elements of the system described in this document. It is understood that elements of the described system can operate either individually or with one or more other elements of this system to accomplish a unique method of remotely assessing and controlling energy use, energy loads, adjusting energy loads, distributed energy resources, distributed energy generation, distributed energy storage, and or controlling energy supply side generators, microgrids, or a grid.

It is recognized that the system in FIG. 1 can be used in other non-energy related applications and to send messages to non-energy devices, where the controller 108 comprises an access control device, a point of sale device, a process equipment, a computer executing instructions, a transportation vehicle's controller, a water flow controller, a gas flow controller, a valve, a direct load controller, or the like.

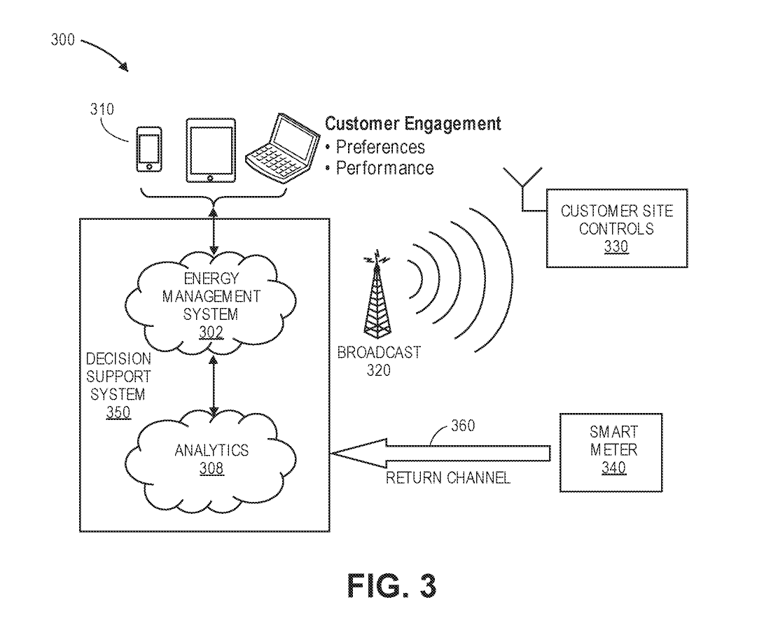

FIG. 3 illustrates a broadcast energy demand and response system 300 comprising customer interfaces 310 for receiving user input, an energy demand support system 350, a broadcast system 320, and control devices 330. The energy decision and support system comprises an energy management system 302 and analytic software or analytics 308.

The customer interfaces 310 present users with choices on energy usage, including preferences for comfort level or temperature levels that may be adjusted relative to information about energy costs and captures user preferences. For residential users this may include lifestyle choices related to heating and cooling, pool pump operation, lighting, operation of appliances, hours or days at home, and the like. For commercial customers, preferences related to heating and cooling profiles, hours of occupancy or operation, timing of equipment operation, system adjustments, participation in demand reduction events, responses to other business, environmental, weather, pricing levels, schedules and capacities of loads that can be time shifted, and the like. Data from the customer interfaces 310 representing customer preferences and inputs is sent to the energy management system 302.

The analytics 308 communicate with utility facilities, power aggregators, grid operators, microgrid controllers, generation controllers, distributed energy resources controllers, or third party databases that provide demand response or other energy reduction and/or increase time data or criteria. The analytic module or analytics 308 of the demand management decision support system 350 described herein contains data representing the historical baseline for addressable sets of loads under varying conditions such as weather, time of day, day of year, or events. The decision support system 350 can make projections of the aggregate available load that can be shed, aggregate capacity of load that can be increased, aggregate additional power capacity that can be generated, aggregate additional power capacity that can be stored, from differing demand management actions, such actions being implemented via broadcast signals sent to selectively addressable subsets of end point energy consuming devices. Modeling of such alternatives and projections of probable impact across the addressable population of energy users is used to present alternative options for achieving goals of demand management. Data representing the energy information is sent to the energy management system 302.

The intelligence for the energy management and control system 302 can be hosted on a dedicated server or in a cloud based server configuration. In certain embodiments, the energy management system 302 comprises an energy intelligence database and microprocessor.

The database comprises fixed and/or variable information on customer and customer site equipment, subsystems, and system adjustment points and may also include data such as building square footage, building envelope characteristics, construction materials, type and capacity of HVAC and other energy consuming equipment, geographic location, use, typical occupancy, historical energy consumption, weather, environment, gas use, employee loading, equipment loads, lighting loads, solar irradiance, and the like. Also included in the database are informational details of the devices and controllers 330 that can be communicated with via the system 300. The database may also comprise information on fixed or variable utility tariffs that effect time of use or real time energy pricing.

Inputs to the applications software of the energy management system 302 comprise data from the customer interfaces 310 that maps customer inputs and/or preferences, and data from the analytic software 308 that maps detailed energy reduction options. In an embodiment, energy management data comprises one or more of a demand response, an emergency demand response, an economic demand response, and an ancillary demand response.

In certain embodiments, energy management system 302 comprises a system that controls distributed energy resources in one or more facilities, campus, nanogrids, and/or microgrids.

In certain embodiments, the energy management system 302 comprises one or more of a power generation management system, a battery storage management system, a thermal storage management system, a power distribution management system, a demand response automation server (DRAS), a demand management control system, a microgrid controller, and a distributed energy resource management system.

The energy management system 302 communicates with other components of the system 300. Energy management and control intelligence from the energy management system 302 is provided for transmission to one or more addressable receiving and control devices 330 through FM Broadcast subcarrier signals from the FM broadcast transmission system or other transmission encoding device 320. In an embodiment, the one or more addressable receiving devices 330 comprise a select group of receiving devices 330.

In an embodiment, the transmission encoding device 320 comprises software and hardware that receives addressable digital command, control, and information from other system modules and/or facility owners or operators, and/or utilities and/or third parties and configures this data for broadcast over an FM Broadcast station subcarrier having an Effective Radiated Power of greater than approximately 1 watt. Customer control devices 330 are connected to energy consuming loads or equipment and/or energy monitoring devices.

In some embodiments of the system 300, customer sites may have a return or feedback channel 360 for transmission of information about energy use, environment, occupancy, weather, solar irradiance, natural gas use, and other energy consumption information about the customer site back to the energy management system 302. One example of such a return channel can be data generated by a smart meter 340. In an embodiment, energy consumption information is provided at intervals less than about one hour. In another embodiment, the energy consumption information is provided at intervals less than about fifteen minutes.

With the increased reliance on distributed energy resources, including distributed generation and distributed storage to meet future energy and sustainability goals, the distributed nature of these resources creates challenges and vulnerabilities to the grid operators and DER managers. One challenge is the ability to reach these disparate devices, thousands and millions of them, in real time and simultaneously. Another challenge is to be able to reach them in a secure manner that does not jeopardize the integrity of the power grid. Should an entity be able to control these distributed energy resources, effectively hijacking them, that entity can cause major disruptions and critical failure of an entire power grid. With the existing vulnerability of Ethernet® networked devices to hacking from local and remote locations, the use of Ethernet® channels for control of DERs poses a threat of national implications. The system 300 allows the use of a secure, real time, addressable and large footprint broadcast 320 to send control messages that cannot be hacked from overseas or even locally, while using a less secure but higher bandwidth return channel 360 for feedback, measurement and verification.

In some embodiments of the system 300, the broadcast 320 is used to send control messages to site controls 330 while public or private Ethernet® is used as a return channel 360 from smart meter 340. These embodiments combine the security advantages of the broadcast 320 and the high bandwidth two-way nature of the Ethernet channel 360. If the security of the Ethernet channel 360 is compromised, it does not pose a danger to the management of site controls 330.

In some embodiments of the system 300, the broadcast 320 is used to send control messages to site controls 330 while public or private Ethernet® is used as a return channel 360 from site controls 330. These embodiments combine the security advantages of the broadcast 320 and the high bandwidth two-way nature of the Ethernet channel 360. If the security of the Ethernet channel 360 is compromised, it does not pose a danger to the management of site controls 330.

In some embodiments, smart meter 340 can comprise a non-utility energy meter, a shadow meter, a sub meter, a chiller controller, a roof top unit controller, a central plant controller, a temperature sensor, a water flow meter, a gas flow meter, a pressure sensor, or any other controller, sensor or meter that measures the impact of action taken by site controls 330.

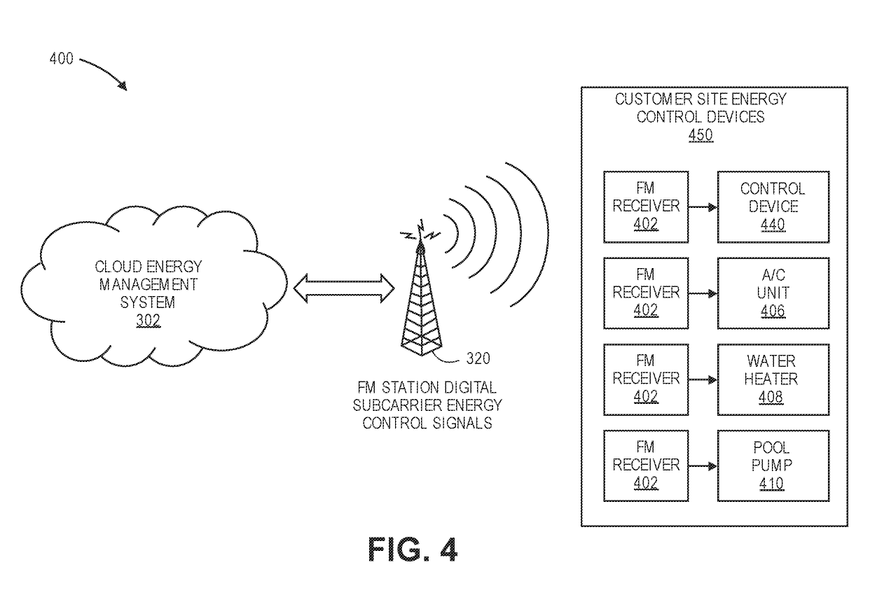

FIG. 4 illustrates a system 400 to transmit energy control or information signals, distal energy loads, energy supply sources, distributed energy resources, micro grids, a smart grid, transformers, power inverters, electric charge controllers, energy storage controllers, automatic transfer switches, direct load controllers, variable frequency drive controllers, power switches, power generators, synchronous motors, asynchronous motors, power factor correction devices, and the like. Signals conveying control commands and other information are generated by the energy management system 302 and transmitted by the broadcast system 320 as FM radio signals to a variety of customer site energy control devices 450. In an embodiment, the energy management system 302 comprises a cloud-based or Internet based energy management system 302. In an embodiment, the broadcast system 320 comprises an FM broadcast system 320 transmitting energy management control signals modulated onto a digital subcarrier.

Each customer site device 450 communicates with an FM receiver 402 that receives the broadcast signals. In an embodiment, the customer site energy control devices 450 comprise a receiver 402 and a control device 404-410. In another embodiment, the receiver 402 is separate and distinct from the customer site control device 450 and the control device 404-410. Examples of customer site devices 450 illustrated in FIG. 4 are, but not limited to, air conditioning units 406, water heaters 408, and pool pumps 410. These devices 406, 408, 410 may situated outdoors or inside buildings or other structures. In an embodiment, the receiver-controller is configured to analyze the energy management or energy decision data. In another embodiment, the control device 450, 404-410, is configured to analyze the energy management or energy decision data.

In some embodiments, more than one broadcast system 320 transmits energy management control signals to receiver 402. In other embodiments, control device 404-410 receives instructions from one or more receivers 402. In further embodiments, a receiver 402 sends the energy management control signals to one or more control devices 404-410.

The receiver 402 decodes the digitized subcarrier data and provides local intelligence to the customer site device 450. In an embodiment, the receiver 402 comprises a microprocessor that decodes the digitized subcarrier data. Decoded digitized subcarrier data comprises, by way of example, but not limited to, system or subsystem addressing information, interpretation data, and the like. The control device 404-410 may provide, based at least in part on the decoded data, analog outputs in the form of relays or electronic controls and/or digital outputs to directly control systems, subsystems, or system adjustments through digital I/O signaling.

The need for real time management of DERs is accentuated by the increasing dynamic nature of the power grid, and the uncertainty of the generation profile of renewable resources such as solar and wind. To accommodate the dynamic nature of these renewable resources, grid operators are having to increasing rely on fast and real time demand response and DER management. Such fast and real time action is needed to provide voltage and frequency stability to the grid. Typically, response times less than 10 seconds are needed for frequency stabilization, with response times less than 4 seconds required in some areas, such as the Pennsylvania-Jersey-Maryland (PJM) Grid.

Historically, grid operators relied on spinning reserves (generators that are running and can be plugged into the grid within seconds) to accommodate swings in grid frequency resulting from mismatch between the energy supplied to the grid and the energy consumed by the devices connected to the grid. To accommodate slower changes in grid conditions, operators rely on the use of peaker plants that can come online within 10 minutes and supply peak power to the grid. Spinning reserves and peaker plants provide the most expensive and highest carbon footprint power.

As the number of renewable resources feeding the grid increases, and regulations emerge that call for 20%-50% and more renewable power in the grid, operators cannot rely solely on the use of spinning reserves and conventional peaker plants to absorb the differences between energy supplied to the grid and energy demanded from the grid.

Public utility regulators are recommending the fast and real time management of distributed energy resources as a way to improve grid stability and counter the uncertain and varying natures of renewable resources.

Managing DERs however has some serious challenges, including the ability to reach a large number of devices simultaneously, in real time and securely. This is made difficult because of the distributed nature of these devices, and because these devices are either not networked, or if networked, are behind a customer's IT firewall and thus cannot be easily reached from outside the customer's network. Devices inside a firewalled Ethernet® local area network can be allowed to dial out of the firewall but stricter restrictions are placed on allowing external devices to dial into the firewall.

The use of an FM broadcast system 400 to send real time secure control messages to distributed energy resources such as control devices 450 places all control devices 450 within real time reach, even if they are behind a customer's IT Firewall. The FM broadcast signal can be used to send the actual energy management control signal to control devices 450, or can be used to send instructions to control devices 450 to ‘dial out’ of the Firewall and into the cloud energy management system 302 to receive instructions.

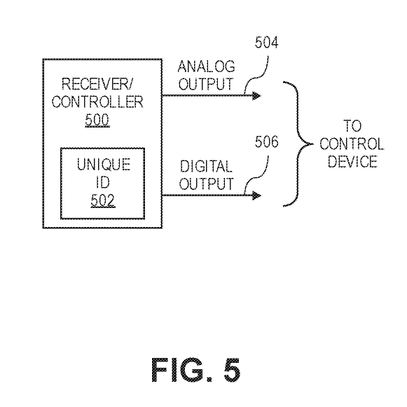

FIG. 5 illustrates an exemplary addressable energy efficiency and demand response receiver/controller 500. In an embodiment, the receiver/controller 500 is an FM Broadcast station receiving device for the purpose of controlling, cycling, or remotely adjusting energy loads, energy supply sources, and/or micro grids, and/or a smart grid, and/or transformers. The receiver/controller 500 can be remotely located on or near a customer site energy control device 450, 404-410. The receiver/controller 500 incorporates intelligence and comprises a microprocessor and firmware or software. The receiver/controller 500 comprises a unique identity 502 can be addressed for signaling and/or controlling devices individually or as a group such, as devices of a predefined type within a given local utility service area. Upon decoding its unique address, the receiver-controller 500 responds to FM broadcast subcarrier signals directed to its address and generates analog outputs 504 or digital outputs 506 that may be used to turn devices or systems on or off, cycle devices or subsystems of devices on or off, send energy information to devices, send non energy information to devices, and/or control adjustments or set points of energy loads and their systems or subsystems. In an embodiment, the receiver-controller 500 provides energy management data to the energy control devices 450, 404-410 using one or more of Zigbee®, 802.11, TCP/IP LAN, ModBus®, BacNet®, Power Line Carrier®, and the like.

In an embodiment, receiver-controller 500 connects to the control device using standard interfaces and connectors such as USB, RS-232, RS-485, parallel ports, or CEA-2045.

In an embodiment, the receiver-controller 500 Comprises® an Ethernet connection or other wired or wireless communication channels to connect to remote databases, remote servers, cloud databases, cloud platforms, and/or other receiver-controllers 500.

### OTHER EMBODIMENTS

In an embodiment, a portable and mobile network of devices and subsystems operates jointly or separately and comprises wide area distribution of Emergency Alert functionality through use of digital FM subcarriers, and/or Digital TV subcarriers, and/or Digital Cellular systems, and/or Digital Cable broadcasts, and/or Digital Satellite broadcasts, and/or LAN, and/or WAN interactive systems through enabled fixed, and/or portable, and/or mobile devices.

Another embodiment comprises devices, systems of devices, and software including of one or more structured or unstructured databases, relational and non-relational databases, SQL and non-SQL databases such as Hadoop® that address and communicate with fixed, and/or portable, and/or mobile devices with Emergency Alert, and/or digital Entertainment, and/or remote device control, and/or digital information. Such cloud based network “traffic director” uses structured, and/or unstructured, and/or relational, and/or non-relational database processing functions and is enabled to address wireless reception enabled fixed, and/or portable, and/or mobile devices. Such device directs the method and Broadcast Station Subcarrier that is used to wirelessly transmit aforementioned information, entertainment, and/or Emergency alerts into such devices through Digital FM subcarrier broadcasts, and/or Digital TV subcarrier broadcasts, and/or Digital Cable broadcasts, and/or Digital Satellite broadcasts, and/or Digital Cellular interactive systems, and/or LAN, and/or WAN interactive systems.

An embodiment comprises Medium Wave AM, and/or VHF FM, and/or VHF/UHF TV Broadcast Station digital subcarrier modulator to impress digitally encoded information and alert signals that include EAS, Homeland Security, Police, Fire, or Utility (DR) information and alerts upon a Broadcast Station RF exciter for wide area wireless distribution and dissemination of information and alert signals where the main RF carrier Broadcast Station transmitting power level is greater than 10 watts.

An embodiment comprises Medium Wave AM, and/or VHF FM, and/or VHF/UHF TV Broadcast Station digital subcarrier modulator to impress digitally encoded information upon a Broadcast Station RF exciter for wide area distribution and dissemination of software programs, books, magazines, news, information, audio, video, and/or equipment firmware updates where the main carrier transmitting power level is greater than 10 watts.

Another embodiment comprises direct individual device reception and subcarrier demodulation of information, entertainment, and/or direct control of devices through AM, FM, TV, Broadcast Station digital broadcast subcarrier signals without the use of intermediary wired or wireless relay points.

Another embodiment comprises localized reception and wireless relay of information, entertainment, and/or control of devices received primarily from AM, FM, TV, satellite digital broadcast subcarrier signals through intermediary wireless Wi-Fi®, WiMax®, or cellular wireless relay for enhanced local redistribution.

Another embodiment comprises received broadcast subcarrier alerts to initiate receiver actions or control of local devices, systems, or facilities (can include DR).

Another embodiment uses received broadcast subcarrier alerts to provide information and alerts that are suitable for alerting visually handicapped, audibly handicapped or non-English speaking recipients.

Another embodiment comprises local intelligence about facility location, facility operations, facility occupancy, facility energy use, local fire alarms, smoke alarms, lighting levels, CO2 levels, solar power levels, wind speed, EV charging activity, etc. to act as localized gating of controls that can be activated by subcarrier information and alerts that are received from AM, FM, or TV cellular, satellite, Wi-Fi® or WiMax® digital broadcast subcarrier signals broadcast signals.

Another embodiment comprises Geo Centric localized gating on wireless broadcast digital subcarrier receiving device, automobile, portable device, or at facility level network to match specific Geographically targeted EAS or utility DR transmission with targeted device reception.

Another embodiment comprises a multiplicity of alert signals that include inputs from local, regional, or national EAS, Local Police or Fire, or Utility DR alerting using either EAS signaling CAP (common alerting protocols), DTMF signaling, or DRAS or other alerting protocols without limitation.

Another embodiment comprises direct wireless broadcast subcarrier control of dimmers, on/off switches, VFD, or thermostat settings.

A method and system of devices and algorithms that can be used to rapidly dispatch, redirect, or control energy loads based on one or more inputs through wide area wireless FM Broadcast station distribution or through groups of FM Broadcast stations is provided. System, method, and devices that are described herein for illustrative and non-limiting purposes utilize one or more user defined inputs, and/or automated signaling, and/or analytic inputs that map automated addressable device and/or distribution control signals that are conveyed to distal energy controlling devices, loads, load controllers, and/or energy producing or distributing systems through one or more FM Broadcast Station Sub carriers to meet a multiplicity of requirements that control the state of energy loads, shed energy loads, cycle energy loads, and/or remotely adjust energy load system settings. System can be used to control or redirect the distribution of power generating and power transmission facilities, and/or micro grids, and/or sections of the grid and/or smart grid.

Another embodiment comprises an FM Broadcast subcarrier reception device that is software addressable and directly or indirectly controls distal Energy loads.

Another embodiment comprises an FM broadcast subcarrier reception device that is simultaneously or approximately simultaneously tuned to one or more broadcast frequencies, such as through the use of multiple antennas and decoders, which then allows more than one broadcast station to communicate with the same reception device.

Another embodiment comprises an FM broadcast subcarrier reception device that can be digitally tuned to one or more broadcast frequencies, thus allowing the reception device to scan multiple frequencies and select the broadcast frequency that has the highest level of signal-to-noise ratio, and best broadcast signal quality and integrity.

Another embodiment comprises FM Broadcast sub carrier reception device that is software addressable and digitally connects to either local wired or wireless WiFi®, Zigbee®, or Ethernet® Router for localized and addressable analog relay control or digital control of energy loads or energy load controllers.

Another embodiment comprises a specific control signal sequence that is originated at a server and imparted onto a broadcast station sub carrier specifically in response to a need or desire to control addressable energy loads and/or distribution systems, and/or devices, and/or control energy loads over wide geographic areas in response to specific signaling over FM Broadcast stations to initiate actions to turn loads on or off, cycle energy loads, reset operating parameters or set points of energy loads, redistribute, or shed energy loads.

Another embodiment comprises wide area wireless FM Broadcast transmission of signaling to control the action of geographically dispersed and addressable energy control devices that is based on the prediction of or the measured amount of energy loads being drawn from an energy supply side grid, micro grid, smart grid, or other energy supply distribution network.

Another embodiment comprises wireless control FM Broadcast receiving devices that receive and respond to control signals that are transmitted by an FM broadcast station sub carrier for the purposes of supply side demand energy reduction requirements to prevent overloading of an energy supply side grid, smart grid, micro grid, or natural gas or water pipeline. Demand Response and Automated Demand Response Signals.

Another embodiment comprises wide area geographically dispersed wireless FM Broadcast station sub carrier devices that receive and respond to control signals transmitted by a broadcast station sub carrier for the purposes of demand side energy reduction requirements that emanate from a local or cloud based energy analytic system to prevent excessive use of, excessive cost of, or waste of energy in a facility.

Another embodiment comprises direct wireless broadcast sub carrier communication and control signals for control of dimmers, on/off switches, variable frequency AC motor drivers (VFD), or thermostat settings.

Another embodiment comprises localized real time or near real time (specific) facility environmental conditions that act as automated or manual gating of device, system, or facility control.

Another embodiment comprises remote on/off control of Solar energy producing or wind energy producing systems by utility, Police or Fire officials in case of Fire or other events that affects safe access to facilities where such systems are located or provide power to such facilities.

Another embodiment comprises wide area geographically dispersed wireless control devices that receive and respond to control signals that are transmitted by an FM broadcast station Sub carrier for the purposes of controlling the temperature and/or fan speed settings of individual or a group of thermostats or other controls that are used to control an HVAC, AC system, heat pump, or water heater.

Another embodiment comprises wide area geographically dispersed wireless control devices that receive and respond individually or as a group of energy load controlling devices to FM Broadcast signal control signals or the purposes of controlling individual or a group of lighting control dimmers or lighting on/off switches and/or relays.

Another embodiment comprises wide area geographically dispersed wireless control devices that receive and respond to control signals that are transmitted by a broadcast station sub carrier for the purposes of controlling valves, compressors, air handlers, chillers, and boilers of any type in an HVAC system.

Another embodiment comprises wide area geographically dispersed FM Broadcast wireless control devices that receive and respond to control signals for the purposes of controlling an HVAC system temperature control that heats water for purposes of delivering hot water to hot water reheating coils.

Another embodiment comprises wide area geographically dispersed wireless control devices that receive and respond to control signals that are transmitted by a broadcast station sub carrier for the purposes of controlling the activation of an HVAC system hot water “reheat coil” system and its valves.

Another embodiment comprises wide area geographically dispersed wireless control devices that receive and respond to control signals that are transmitted by a broadcast station sub carrier for the purposes of controlling electric vehicle charging stations.

Another embodiment comprises wide area geographically dispersed wireless control devices that receive and respond to control signals that are transmitted by a broadcast station sub carrier for the purposes of control of battery storage, thermal storage, or other energy storage systems.

Another embodiment comprises wide area geographically dispersed wireless control devices that receive and respond to control signals that are transmitted by a broadcast station sub carrier for the purposes of control of pool or spa water pumps or water heating systems.

Another embodiment comprises wide area geographically dispersed wireless control devices that receive and respond to control signals that are transmitted by a broadcast station sub carrier for the purposes of control of variable speed drives or variable frequency motor controllers.

Another embodiment comprises wide area geographically dispersed wireless control devices that receive and respond to signals that are transmitted by a broadcast station sub carrier for the purposes of relaying energy or non-energy information to devices not limited to energy data, energy information, energy management data, or other data related to energy usage. Examples of independent data are interval meter, submeter, or smartmeter data, natural gas data, occupancy sensor data, CO₂ or oxygen sensor data, HVAC system set point data, lighting level data, power grid parameters, microgrid parameters, utility data, geographic data, schedule data, pricing data, pricing signals, BIM (building information management) data, system specification data, equipment specification data, equipment performance data, events log data, customer data, time series data, target parameters, security keys, confirmation codes, decision metrics, weather data such as predictive or actual weather patterns, predictive or actual cloud cover, predictive or actual rain, predictive or actual wind patterns, and predictive or actual local environmental conditions, solar irradiance data, other data conditions that are independent but relevant to energy use, automated demand response (ADR) signals, real time or dynamic energy supply and pricing signals, emergency or other non-emergency information, solar or wind generator output, manual confirmation of actions, automated confirmation of actions, and the like.

Another embodiment comprises wide area geographically dispersed wireless receiver devices that receive and respond to signals that are transmitted by a broadcast station sub carrier for the purposes of providing feedback in control loop comprising of an energy management system, a receiver device, a controller device and a meter. The receiver device receives instructions from the energy management system via FM and relays instructions to the controller device; the controller device takes action that is measured by the meter. The meter sends feedback to the energy management system via Ethernet or other communication channel. The energy management system relays the feedback to the receiver device via FM. The receiver device in turn relays the feedback to the controlled device. The controlled device takes new action based on the feedback. The outcome of the new action is measured by the meter and sent as new feedback to the energy management system. The cycle is repeated, where the wireless receiver device serves to close the feedback loop between a controller device that is not connected to the Ethernet® and an Ethernet® connected meter measuring the outcome of the actions taken by the controller device.

### Secure Communications

Not one method of encryption is infallible. Many modern encryption methods rely upon the use of an encryption key using the same channels as the subsequent communication. In the old days, keys used to be sent via messenger, mail or other different forms of communication.

Today, digital encryption and decryption keys are sent using the same digital communication channel that is used for sending and receiving the encrypted messages. For encryption algorithms, a key specifies the transformation of plaintext into ciphertext, and vice versa for decryption algorithms. A code is a method used to transform a message into an obscured form so it cannot be understood. Special information or a key is required to read the original message.

Embodiments described herein provide methods for secure communication over one or more preferred channels, referred to as Path 1, using cryptographic protocols relying on code or keys sent on one or more separate communication channels, referred to as Path 2, which is different or disparate from Path 1. Path 1 comprises at least one of a preferred communication medium, a preferred communication protocol, a preferred communication channel, and/or a preferred network. Path 2 comprises at least one of a communication medium, a communication protocol, a communication channel, and/or a network that is separate and distinct, or disparate from the preferred communication medium, communication protocol, communication channel and/or network associated with Path 1. In one embodiment the preferred communication channel comprises Ethernet® communication, while the separate communication channel used to send the encryption keys are one or more digital FM subcarriers at one or more frequencies of an FM broadcast.

The use of subcarrier FM provides additional security because of its stealth mode of operation, or in other words, the subcarrier frequency used can be kept a secret, as well as the limited geographic footprint that FM radio waves have, or in other words, for someone to intercept a signal, they have to be within the geographic range of the FM station. Digital FM broadcasts also benefit from being encrypted themselves, using keys that are either embedded in the receivers upon manufacturing, or transmitted using Hash cryptography or other types of cryptography (e.g. Diffie-Hellman, a private and public key, or the like), adding to the security of the multi-communication system security scheme.

The public Ethernet® has many advantages, such as availability, high speed and large bandwidth. However, its security can be compromised making the use of Ethernet® channels for critical missions contain an element of risk. Such critical missions include managing electrical grid components, Grid components, Microgrid components, irrigation pumps, motors, energy storage devices, energy generation devices, distributed energy resources, Point-of-Sale (POS) machines, ATMs, financial transaction systems, personalized communication devices, personalized media devices, security devices, access control devices, traffic control devices, data beacons, data servers, IT devices, and other IoT devices.

The proliferation of IoT devices poses a significant challenge to keep the communication with and the control of IoT devices secure. Conventional encryption techniques (symmetric and asymmetric keys, for example) may not be applicable to the large scale use with thousands and millions of IoT devices, and the risk associated with a potential compromise of the communication may warrant additional security measures. New methods of securely and rapidly distributing cryptographic keys to a large number of discrete IoT devices are needed and embodiments of new methods are described herein.

An issue in Internet of Things (IoT) is security of communication from one device to another, and between devices and the cloud. Security relies on the use of encryption keys. If keys are static, then they are quite secure until the code is cracked and then the security of all devices is compromised. Having a dynamic key in itself poses a challenge and a risk as nobody wants the keys to be decoded during transmission. There are embodiments that use computational resources and algorithms. In an embodiment, the FM airwaves pass on at least a part of the encryption or security key.

The FM transmissions can be used to provide encryption codes, encryption keys, or security codes to IoT's devices, which can be updated monthly, daily, or every minute depending on the requirements. The receiving unit will not need a lot of computational resources to use the updated encryption codes, encryption keys, or security codes and to share them with other devices. Security keys can be allocated by type of device, its location, region, time of day, etc. This will be significantly important for devices that are used to control things across the smart grid and distribution systems, in addition to devices used in a home or facility.

In an embodiment, an encryption key is used to decode messages sent to control devices, such as devices connected by the Internet of Things. For security, at least a portion of the encryption key is send to a receiving device via a first communication technology and a remaining portion of the encryption key is sent to the receiving device via a second communication technology different or disparate from the first communication technology.

In an embodiment, the first communication technology can comprise one or more of AM, FM, or TV cellular, satellite, Wi-Fi® or WiMax® broadcast subcarriers; AM, FM, or TV cellular, satellite, Wi-Fi®, WiMax® digital broadcast subcarriers; and the like. In an embodiment, the second communication technology can comprise one or more of wired or wireless networking protocols, such as WiFi®, Zigbee®, Ethernet®, for example; cellular communication; the Internet; local area networks; wide area networks; and the like. For example, The Zigbee® standard operates on the IEEE 802.15.4 physical radio specification and operates in unlicensed bands including 2.4 GHz, 900 MHz and 868 MHz.

The receiving device combines the two portions that were sent using disparate communication technologies to provide a complete or whole encryption key. The ratio of the portion of the encryption key sent via the first communication technology to the remaining portion send via the second communication technology can vary. For example, the ratio can be 50%/50%; 100%/0%; 0%/100%; 25%/75%; 67%/33%; and the like. In other embodiments, the portion of the encryption key sent via the first communication technology can vary from 0% to 100° A and all percentage between 0% and 100° A and the remaining portion send via the second communication technology can vary from 100% minus the portion of the encryption key sent via the first communication technology. In an embodiment, updating the encryption key comprises varying a ratio of the first portion of the encryption key transmitted via the terrestrial wireless VHF FM Broadcast radio station to the second portion of the encryption key transmitted via the second communication technology.

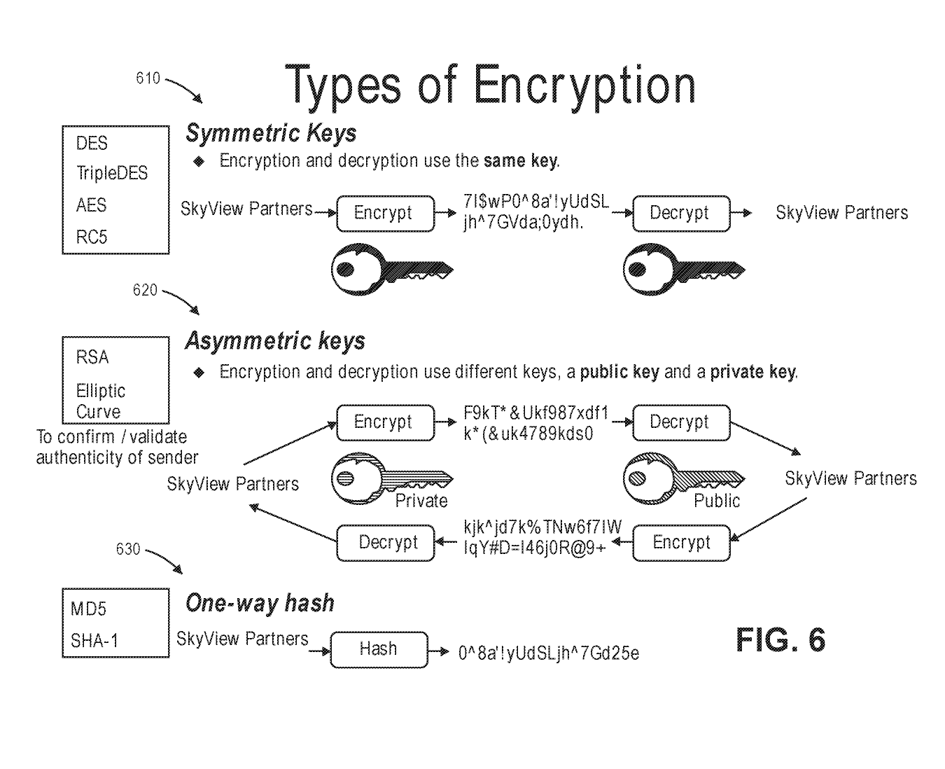

FIG. 6 illustrates three types of exemplary encryption. A first type of encryption 610 illustrates encryption and decryption using the same key or symmetric keys. A second type 620 illustrates encryption and decryption using different keys, such as a public key and a private key, or asymmetric keys. A third type of encryption 630 illustrates a one-way hash to encrypt plain text.

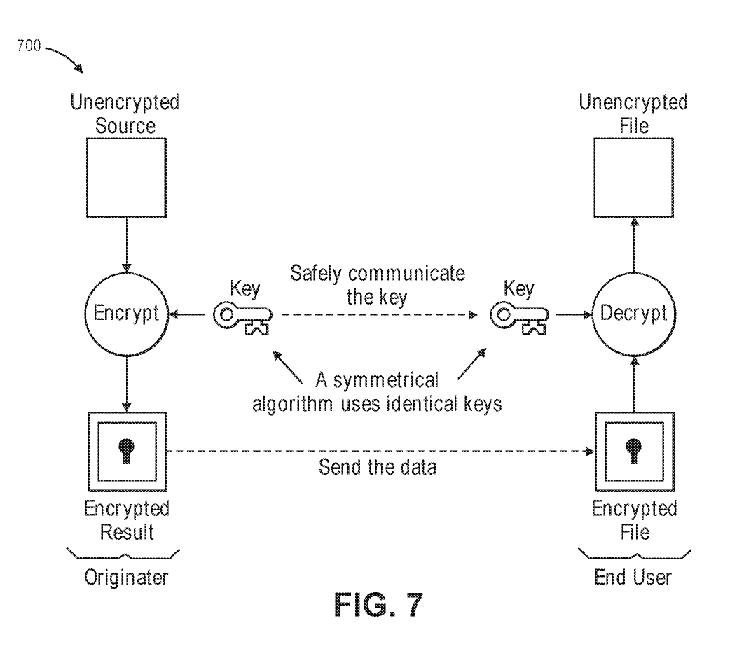

FIG. 7 illustrates an embodiment of a symmetric encryption scheme 700 that uses identical keys to encrypt at a file at a source and decrypt the file at an end user.

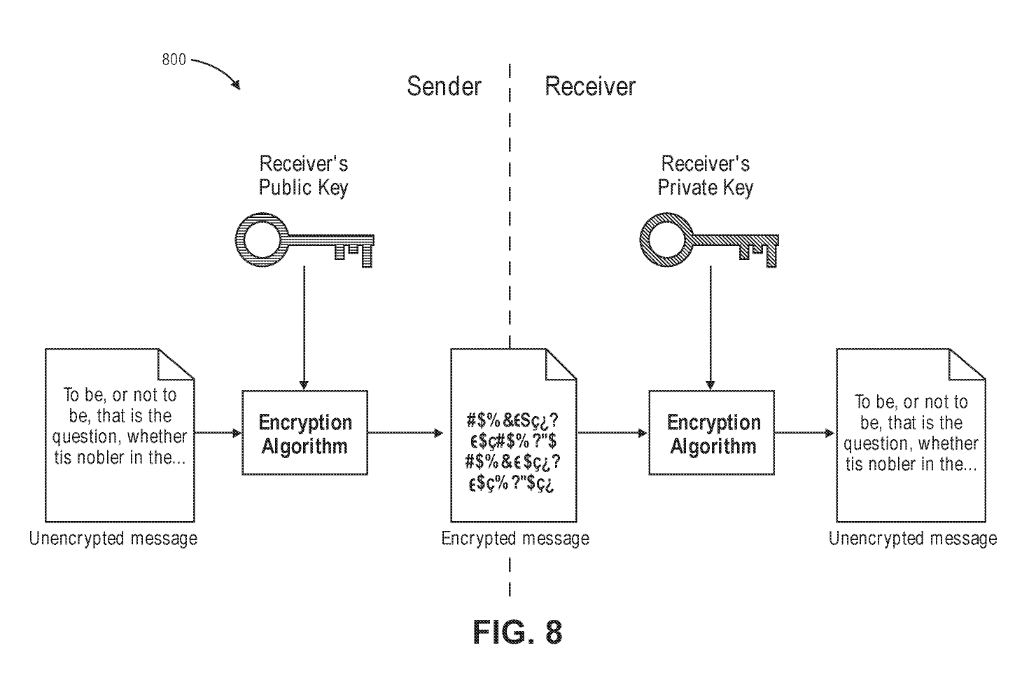

FIG. 8 illustrates an embodiment of an asymmetric encryption scheme 800 where the sender comprises the receiver's public key and the receiver comprises the receiver's private key.

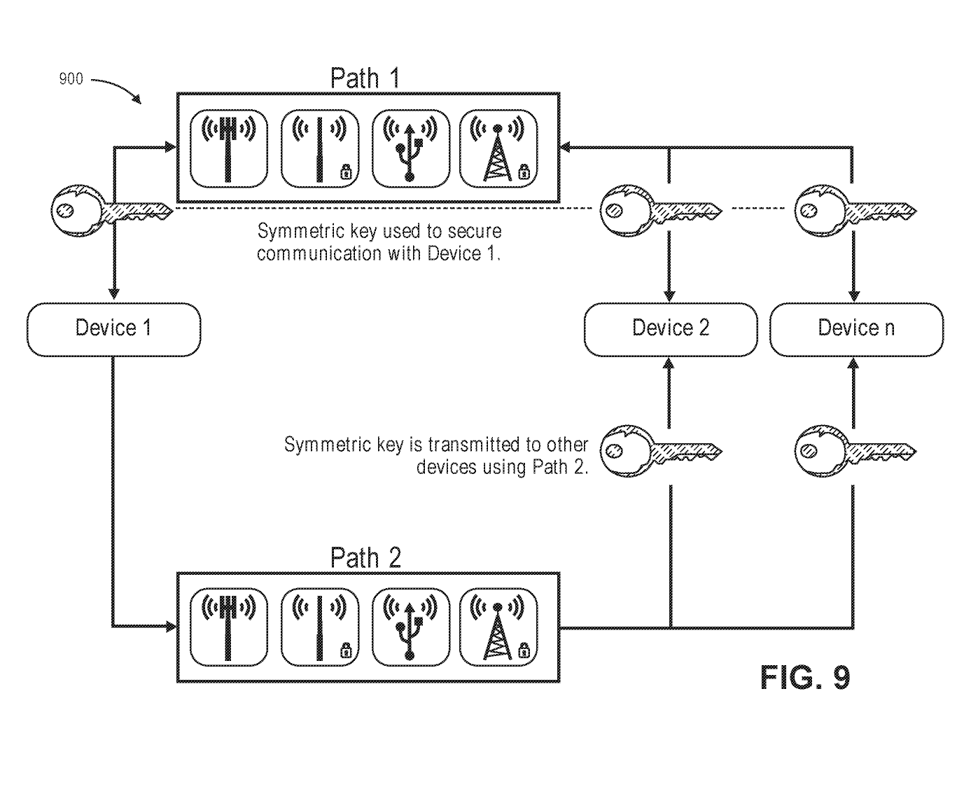

FIGS. 9-16 illustrate encryption/decryption scheme embodiments. In an embodiment, Device 1-Device n comprise devices, such as but not limited to IoT devices, energy devices, distributed energy resources, and the like. In an embodiment, Device 2-Device n comprise receiver/controller 500. Device 1 comprises a controller that is configured to issuing commands to other devices. In an embodiment, the decision support system 350, the energy management system 302, or the analytics 308 comprise Device 1. In an embodiment, one of Device 1 and Device 2 comprises a controller such as a device in a cloud energy management system 302, issuing commands that are addressed to the other devices.

In an embodiment, the communication protocols, communication networks and/or communication media on Communication Path 1 are different from the communication protocols, communication networks, and/or communication media on Communication Path 2. In an embodiment, Communication Path 1 comprises one or more of Ethernet® communication protocols, cellular broadband communications, 2-way RF networks, and the like, and Communication Path 2 comprises FM broadcast communications, such as one or more FM subcarriers.

FIG. 9 illustrates an embodiment of a symmetric encryption scheme 900 using disparate communication media, disparate communication protocol, or disparate paths. Device 1 and Device 2-Device n interface with Communication Paths 1 and 2. In the symmetric encryption scheme 900, Device 1 is issued an encryption key and interfaces with Communication Path 2 to transmit the key to Device 2-Device n along Communication Path 2. Device 2-Device n interface with Communication Path 2 to receive the key from Device 1 and use the key to encrypt and decrypt messages to and from Device 1 that are transmitted and received via Communication Path 1. In the encryption scheme 900, Device 1 and Device 2-Device n receive the same encryption key or in other words, use a symmetric encryption key.

In one embodiment, a new symmetric key for communication via Communication Path 1 is sent to Device 2-Device n via Communication Path 2 at regular intervals such as every hour, day, week or month.

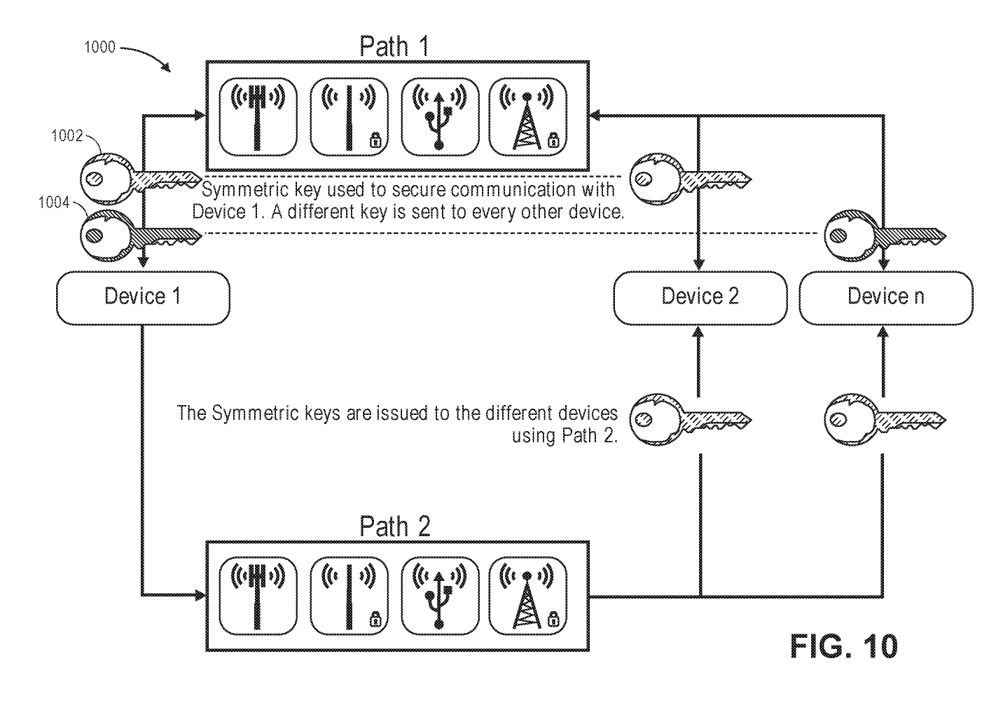

FIG. 10 illustrates an embodiment of a symmetric encryption scheme 1000 using disparate communication media. In the symmetric encryption scheme 1000, Device 1 is issued 1 to n−1 encryption keys, such that Device 1 is issued a different encryption key for each Device 2-Device n that Device 1 is to securely communicate with. Device 1 transmits the first encryption key 1002 to Device 2 via Communication Path 2, . . . , and transmits the n−1^{th} encryption key 1004 to Device n via Communication Path 2. Device 2 receives the first encryption key 1002, . . . , and Device n receives the n−1^{th} encryption key from Device 1 and Device 2-Device n use their respective received encryption key 1002, 1004 to encrypt and decrypt messages from Device 1 transmitted and received via Communication Path 1. In the encryption scheme 1000, different symmetric key pairs are sent to pairs of devices. Each pair of devices uses a symmetric key algorithm that is different from the symmetric key algorithm used by another of the pairs of devices. Each pair of devices comprises Device 1 and one of Device 2-Device n.

In an embodiment, a first symmetric key algorithm is used to securely communicate between Device 1 and a subset of Device 2-Device n and a second symmetric key algorithm, different from the first symmetric key algorithm is used to securely communicate between Device 1 and a different subset of Device 2-Device n.

In one embodiment, the symmetric key pairs for communication via Communication Path 1 are changed at regular intervals such as every hour, day, week, month, or the like.

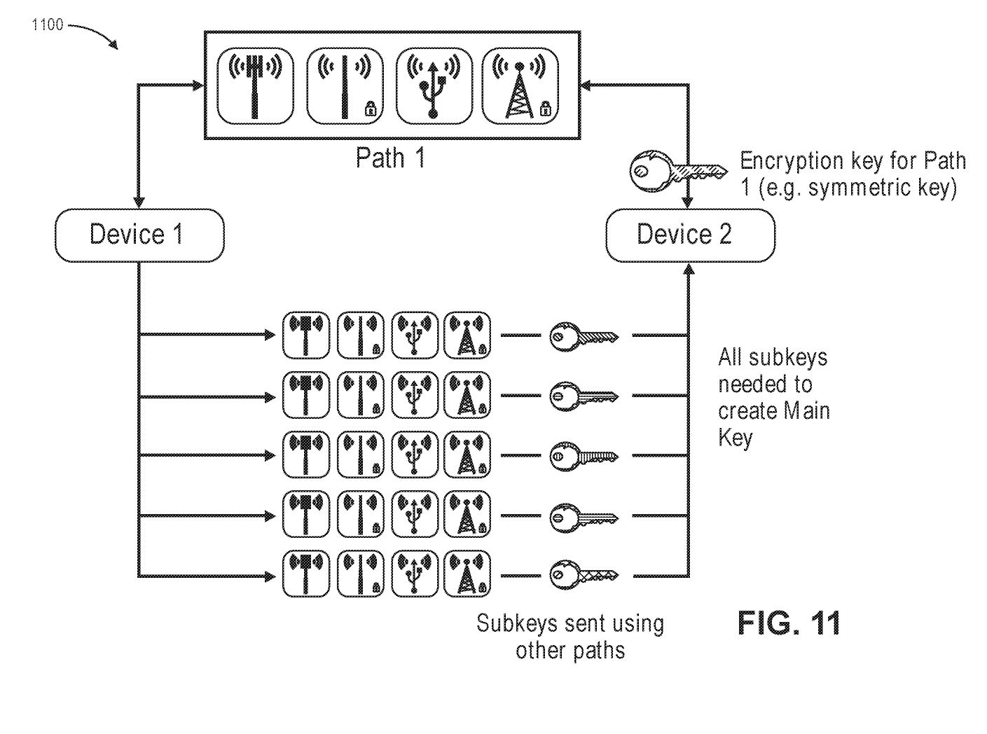

FIG. 11 illustrates an exemplary encryption scheme 1100 using subkeys and a symmetric key algorithm. In the encryption scheme 1100, the encryption key used the encode and decode messages sent via Communication Path 1 comprises a combination of multiple sub-keys sent over multiple discrete communication channels, such as FM, 4G, RF, Ethernet®, and the like, that are different from Communication Path 1.

Device 1 comprises an encryption key and transmits a plurality of subkeys of its encryption key across multiple communication media, and networks, or using multiple communication protocols to Device 2. The multiple communication media, networks, or protocols are different from the communication medium/media, network, or protocols that comprise Communication Path 1. In an embodiment, a subkey is a partial key and comprises a portion of the encryption key. Each subkey sent to Device 2 comprises a different portion or different subkey of the encryption key. In an embodiment, all of the subkeys or partial keys are needed to form the encryption key for Device 2 to permit encrypted communications between Device 1 and Device 2 via Communication Path 1. In another embodiment, one or more subkeys are used to form an encryption key that permits encrypted communications between Device 1 and Device 2 via Communication Path 1 (the Communication Path 1 encryption key).

In one embodiment, the one or more subkeys are concatenated to form the Communication Path 1 encryption key. In another embodiment, different algorithms are used to combine the one or more subkeys to create the Communication Path 1 encryption key.

In one embodiment, the multiple paths used to send the subkeys comprise FM digital subcarriers at different frequencies. In another embodiment, Device 2 comprises a software-defined radio or digitally-tuned radio that can be used to tune to the different stations carrying the different subkeys.

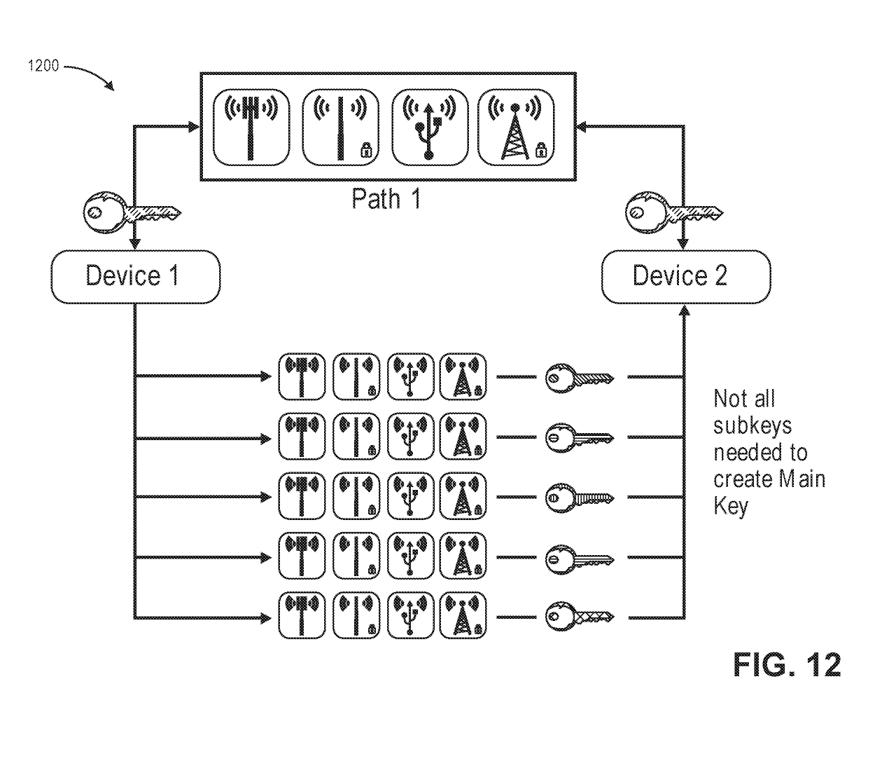

FIG. 12 illustrates an exemplary encryption scheme 1200 using subkeys. In the encryption scheme 1200, the encryption key used to encrypt and decrypt messages transmitted and received via Communication Path 1 comprises a combination of one or more sub-keys sent over multiple discrete communication channels, such as FM, 4G, RF, Ethernet®, and the like. In an embodiment, Communication Path 1 comprises a network, a communication protocol, or a communication medium that is different from any of the networks, communication protocols, communication media, or networks used to transmit the subkeys. Encryption scheme 1200 differs from encryption scheme 1110 in that not all of the subkeys are needed to create the encryption key for Communication Path 1.

Device 1 comprises an encryption key and transmits one or more subkeys of the encryption key across multiple communication media, networks, or using multiple communication protocols to Device 2. The multiple communication media, networks, or protocols are different from the communication media, network, or protocols associated with Communication Path 1. Each subkey sent to Device 2 comprises a different portion or different subkey of the encryption key. In an embodiment, one or more subkeys are used to form the Communication Path 1 encryption key. In another embodiment, a subset of the subkeys is used to form the encryption key encrypting and decrypting messages transmitted and received via Communication Path 1.

Different cryptographic protocols, such as, for example, such as Shamir's Secret Sharing Scheme (SSSS), and the like, can be used to combine the subset of subkeys into the encryption key that permits encrypted communication between Device 1 and Device 2 via Communication Path 1. In one embodiment, the encryption key for communication along Communication Path 1 can be reset at regular or irregular intervals using subkeys, partial keys, partial codes, shares, and the like sent via Communication Path 2.

An advantage of encryption scheme 1200 is that if one or more of the paths transmitting at least one subkeys fails, the Communication Path 1 encryption key can still be created. In an embodiment, there is a minimum number of subkeys that need to be received in order to form the Communication Path 1 encryption key. Encryption scheme 1200 is more secure than an encryption scheme that transmits one encryption key.

Cryptographic protocols using asymmetric keys rely on the use of a private key that the sender knows and a matching public key that is made known to all other devices that need to communicate with the sender. When communication is established, the keys are used to confirm to the receiving device the identity of the sending device.

Asymmetric cryptography is also known as public-key cryptography and has two most common uses: The first is for public-key encryption and the second is for digital signatures. In public-key encryption, a sender encrypts the message with the receiver's public key. The encrypted message can only be decrypted with the receiver's private key, which is in the sole procession of the receiver.

Digital signatures rely on the sender generating a hash of a message and using the sender's private key to encrypt the hash. The resulting encrypted code is referred to as the digital signature. One of multiple hash algorithms can be used, such as, but not limited to MD5, SHA-1, SHA-2, where SHA-2 is the current hashing standard. The receiver receives the message along with the digital signature. The receiver computes the hash of the message using the same hash standard used by the sender. The receiver also decrypts the digital signature using the sender's public key possessed by the receiver, yielding the hash generated by the sender. The receiver then compares the hash generated by the sender with the hash generated by the receiver to confirm that the message has not been altered and that the message was sent by the sender/owner of the private key that matches the public key in the receiver's possession.

Asymmetric encryption is more time consuming and resource intensive than symmetric encryption. The distribution of public keys is managed by a Certificate Authority (CA), a company which verifies and confirms the identity of the issuer of public keys and issues a digital certificate that the sender can use to prove ownership of the public key.

Such keys are used, for example, when logging in to a bank account to verify that the host site is actually the bank. The bank comprises a private key and issues a public key to clients who want to login. When the login request is received, the client's computer uses the bank's digital certificate, public key and the security protocols to confirm that the host site is the bank. The bank uses the client's username and password to confirm the identity of the client.

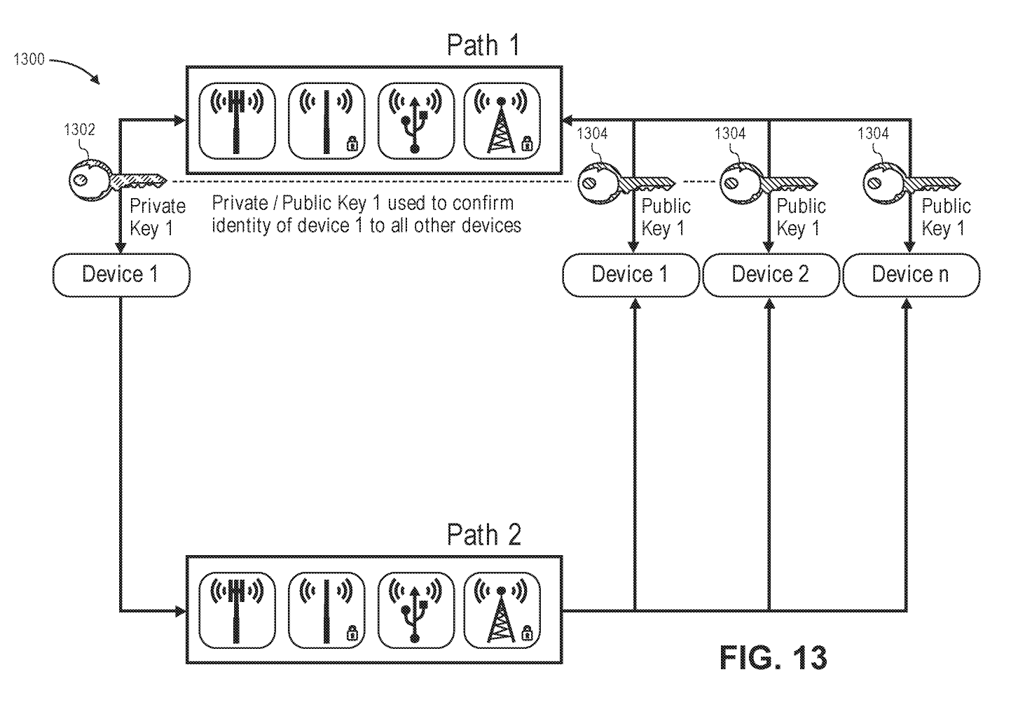

FIG. 13 illustrates an embodiment of an encryption scheme 1300 comprising a private key 1302 and a public key 1304 that is transmitted over a first communication medium for use in communications in a second communication medium. In the encryption scheme 1300, the private key 1302 is issued to and owned by Device 1. In an embodiment, the private key 1302 is associated with Device 1. The public key 1304 is broadcast via the FM broadcast subcarriers associated with Communication Path 2 to Device 2-Device n. The public key 1304 and the private key 1302 are used to confirm the identity of Device 1 to Device 2-Device n for secure communications via Communication Path 1, which is different from the communication medium associated with Communication Path 2.

In an embodiment, the public key 1304 and the private key 1302 are used to confirm the identity of Device 2-Device n to Device 1 for secure communications via Communication Path 1.

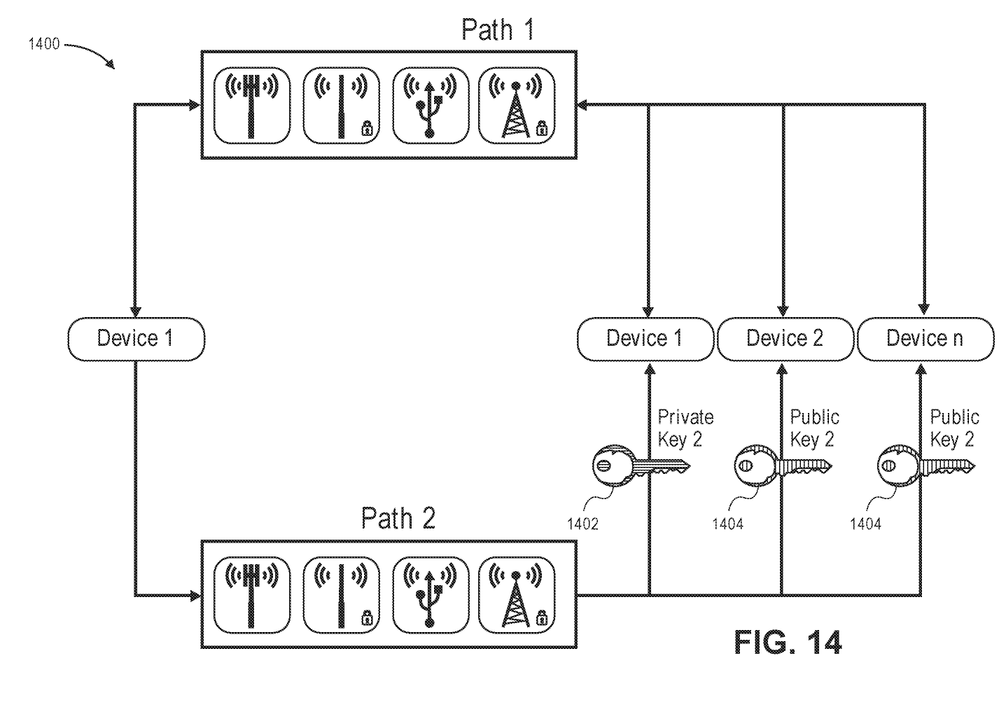

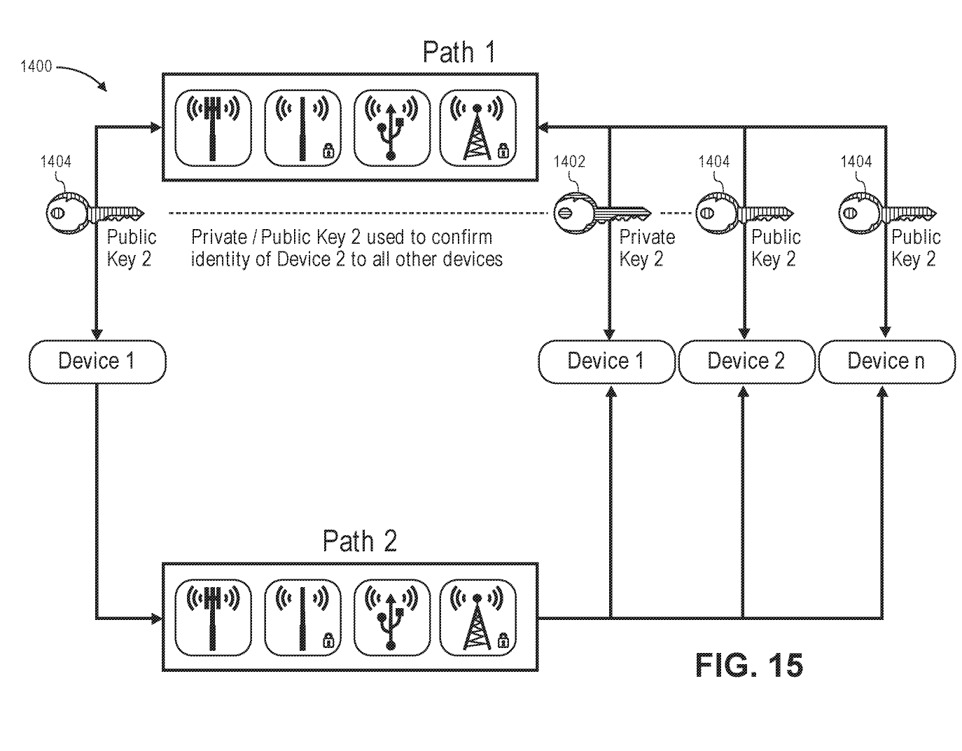

FIGS. 14 and 15 illustrate an embodiment of an encryption scheme 1400 comprising a private key 1402 and a public key 1404 that is transmitted over a first communication medium for use in communications in a second communication medium. In encryption scheme 1400, the private key 1402 is sent to Device 2 via communication medium associated with Communication Path 2, and a matching public key 1404 is broadcast via communication medium associated with Communication Path 2 to one or more of Device 3-Device n. As illustrated in FIG. 15, the private key 1402 and public key 1404 are used to confirm the identify of Device 2 when Device 2 is communicating with one or more of Device 1, Device 3-Device n via the communication medium associated with Communication Path 1.

In another embodiment, the communication medium associated with Communication Path 2 securely transmits the private key 1402 to one or more of Device 2-Device n and the matching public key 1404 to the others of Device 2-Device n, so that the private key 1402 and matching public key 1404 can be used to confirm the identities of the one or more of Device 2-Device n when the one or more of Device 2-Device n are communicating with others of the Device 2-Device n via the communication medium associated with Communication Path 1.

In one embodiment, communication medium associated with Communication Path 2 comprises a digital FM subcarrier while the communication medium associated with Communication Path 1 comprises Ethernet® communication protocols and networks.

In another embodiment, the private key 1402 is sent to Device 2 in part or in whole using multiple paths with other forms of encryption such as SSSS. In another embodiment, Device 1 acts as the Authority issuing private key 1402 to Device 2, and the matching public key 1404 to Device 3-Device n.

In another embodiment, the same private key 1402 is sent to more than one device, and each device combines the same private key 1402 with a unique identifier, such as, but not limited to, a serial number, an IPv6 address, or the like, associated with the receiving device to create a private key unique to each receiving device. This allows for the quick dissemination of private key to a large number of devices via Communication Path 2, such as FM broadcast, while preserving the uniqueness of private key 1402 to each of Device 2-Device n.

In another embodiment, the devices combine the key 1402, 1404 received via the communication medium associated with Communication Path 2 with other data such as, but not limited to, GPS location, time stamp, or the like, to create a unique private key.

Private keys in asymmetric encryption and decryption have expiry dates. In an embodiment, when the private key that is used by Device 2 for secure communication via communication medium 1 or Communication Path 1 expires, the communication medium 2 or Communication Path 2 securely sends a new private key to Device 2 and broadcasts the matching public key to one or more of Device 1 and Device 3-Device n.

In another embodiment, when the private key of Device 1 expires, communication medium 2 or the Communication Path 2 broadcasts the new public key associated with Device 1 to one or more of Device 2-Device n. In another embodiment, when the symmetric key used for communication between Device 1 and one or more of Device 2-Device n via communication medium 1 or Communication Path 1 expires or is revoked, the communication medium 2 or Communication Path 2 is used to securely send a new symmetric key to Device 1 and one or more of Device 2-Device n.

In another embodiment, when the security of communication medium 1 or Communication Path 1 between Device 1 and one or more of Device 2-Device n is compromised, then communication medium 2 or Communication Path 2 transmits new symmetric or asymmetric keys to Device 2-Device n. In one embodiment, one or more FM subcarriers of an FM broadcast band are used to broadcast new public keys to Device 2-Device n.

Security certificates are used in the exchange of asymmetric keys, for example. In another embodiment, when the security certificate of Device 1 that is used for communication along communication medium 1 or Communication Path 1 is compromised, then communication medium 2 or the Communication Path 2 transmits a message to Device 2-Device n to revoke the security certificate of Device 1. In an embodiment, Device 1 prepares the message. In one embodiment, one or more FM subcarriers of an FM broadcast band are used to broadcast a ‘revoke certificate of Device 1’ message to one or more of Device 2-Device n. In another embodiment, security certificates for communication used in communication medium 1 or via Communication Path 1, are revoked using communication medium 2 or via Communication Path 2.

Symmetric or private keys broadcast over one or more communication media associated with Communication Path 2 to a large number of devices can be combined using an algorithm, for example, with information specific to a device, such as its GPS location, its serial number, its IPv6 address, or a local time stamp, to generate device-specific symmetric keys or asymmetric private keys. The advantage of this method is that a large number of devices can have their keys reset at the same time, in the event of a breach of security in the communication medium associated with Communication Path 1 or as a preventive security measure on a periodic basis.

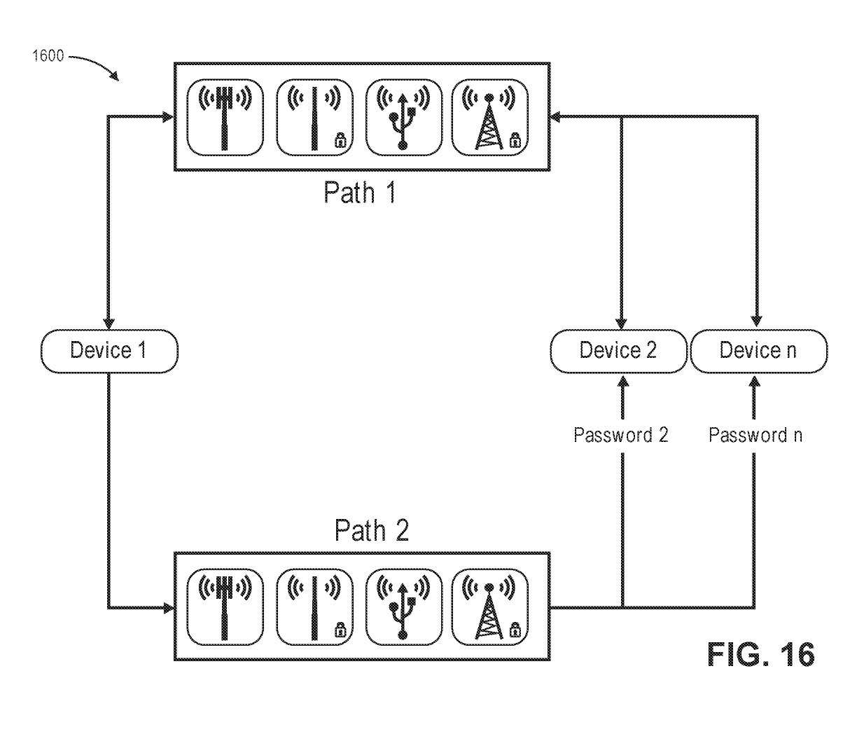

FIG. 16 illustrates an embodiment of a password protection scheme 1600 using disparate communication media. In the password protection scheme 1600, Device 2-Device n use passwords 2-n, respectively, to login to a remote site or Device 1 via the communication medium, network, or protocol associated with Communication Path 1. Communications via the communication medium, network, or protocol associated with Communication Path 2 are used to reset or reissue one or more of the passwords 2-n. In an embodiment, the username comprises a Device ID and does not need to be issued to Device 2-Device n.

In an embodiment, the communication medium, network, or protocol associated with Communication Path 2 can be encrypted using one or more algorithms, such as, but not limited to error correction for FM transmission, one way hash, Diffie-Hellman key exchange, and the like.

In one embodiment, the passwords used for communication via the communication medium, network, or protocol associated with Communication Path 1 can be reset using the communication medium, network, or protocol associated with Communication Path 2 at regular or irregular intervals, such as every hour, day, week, month, or the like. This can be done when the security of the communication medium, network, or protocol associated with Communication Path 1 is compromised or as a preventive measure.

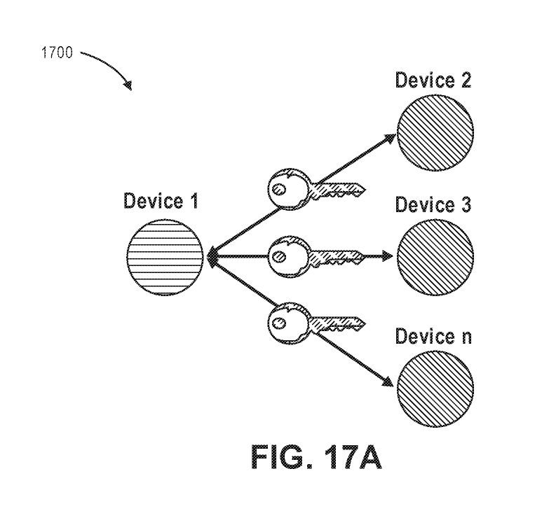

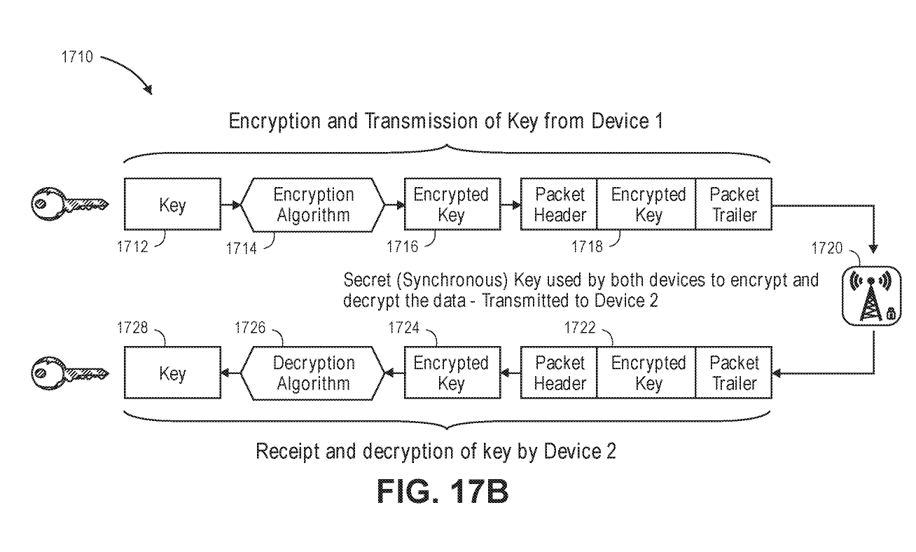

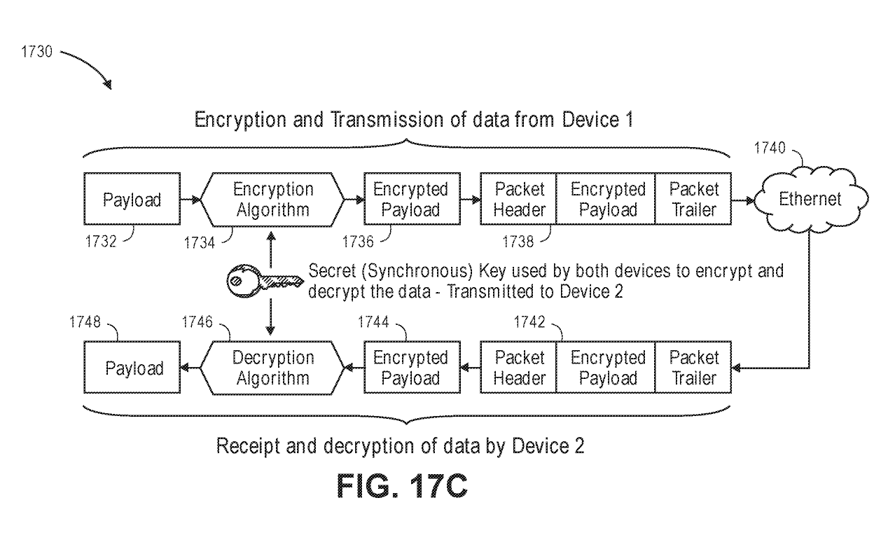

FIGS. 17A-17C illustrate an embodiment of cryptographic key distribution and encrypted data transmission system. FIG. 17A shows a system-level key-distribution hierarchy 1700. Device 2-Device n comprise devices, such as but not limited to IoT devices, energy devices, distributed energy resources, and the like. In an embodiment, Device 2-Device n comprise one or more receiver-controllers 500 that send and or receive communication via two or more separate communication paths. Device 1 comprises a controller that is configured to issuing commands to other devices. In an embodiment, the decision support system 350, the energy management system 302, or the analytics 308 comprise Device 1. Device 1 distributes keys to other devices, as shown in FIG. 17A.

FIG. 17B illustrates an embodiment of key distribution flow from Device 1 to one of Device 2 through Device n. In the illustrated example, the key distribution is from Device 1 to Device 2. The key distribution is transmitted via Communication Medium 2. In FIG. 17B, Communication Medium 2 comprises FM broadcast communications, such as one or more FM subcarriers.

In flow 1710, Device 1 generates a cryptographic key 1712. In an embodiment, the cryptographic key 1712 comprises a symmetric key. The cryptographic key 1712 is encrypted or scrambled through an encryption algorithm 1714, resulting in an encrypted or scrambled key 1716. The encryption algorithm 1714 comprises an error correction code, a cryptographic algorithm using a built-in key shared between Device 1 and Device 2, a key-exchange algorithm using keys exchanged between Device 1 and Device 2, such as Diffie-Hellman, and the like.

In an embodiment, Device 1 and Device 2 share a plurality of built-in keys and choose one of the plurality of keys to use for a particular key distribution transmission based on a key selection scheme. The key selection scheme is based on one or more of geographic, temporal, and frequency diversity, for example. If a key-exchange algorithm such as Diffie-Hellman is used as the cryptographic key of encryption algorithm 1714, the key exchange can take place, at least in part, through transmission via Communication Medium 1.

Device 1 assembles a message 1718 comprising a header, the encrypted key 1716, and a trailer. Device 1 transmits the message 1718 over Communication Medium 2, shown as 1720 in FIG. 17B. Device 2 receives a message 1722. In the absence of transmission or reception error, the message 1722 comprises the same information as the message 1718. The trailer in the message may or may not contain information known to Device 2 prior to Device 2 receiving the message 1722. For example, the trailer may contain padding to pad the message to a certain length, or the trailer may contain information for some function in the system, such as but not limited to a housekeeping function or a Check Sum. Device 2 extracts encrypted key 1724 from the received message 1722. Device 2 decrypts the key using decryption algorithm 1726, resulting in decrypted or clear-text key 1728.

The decryption algorithm 1726 comprises the counterpart to the encryption algorithm 1714. For example, if the encryption algorithm 1714 comprises applying an error correction code by adding parity bits to information bits, the decryption algorithm comprises applying error correction though the use of both information bits and parity bits. In another example, if the encryption algorithm 1714 comprises a symmetric-key cryptographic algorithm, such as, but not limited to AES in encryption mode, then the decryption algorithm 1726 comprises the same symmetric-key cryptographic algorithm in decryption mode.

After Device 2 receives the cryptographic key 1728, Device 1 and Device 2 use the cryptographic key 1728 to encrypt data communications transmitted on Communication Medium 1.

FIG. 17C illustrates an embodiment of encrypted and decrypted communications. In flow 1730, to transmit a data payload 1732, Device 1 applies a symmetric-key encryption algorithm 1734 and key 1712 to generate an encrypted data payload 1736. In an embodiment, the encryption algorithm 1714 is the same as the encryption algorithm 1734. In another embodiment, the encryption algorithm 1714 is different from the encryption algorithm 1734.

Device 1 assembles a message 1738 comprising a header, the encrypted data payload 1736, and a trailer. Device 1 transmits the message 1738 over Communication Medium 1, shown as 1740 in FIG. 17C. In an embodiment, Communication Medium 1 comprises one or more of Ethernet® communication protocols, cellular broadband communications, 2-way RF networks, and the like.

Device 2 receives a message 1742. In the absence of transmission or reception error, the message 1742 comprises the same information as the message 1738. The trailer in the message may or may not contain information known to Device 2 prior to Device 2 receiving the message 1742. For example, the trailer may contain padding to pad the message to a certain length, or the trailer may contain information for some function in the system which need not be protected by encryption.

Device 2 extracts encrypted payload 1744 from the received message 1742. Device 2 decrypts the key using decryption algorithm 1746 and key 1728, resulting in decrypted or clear-text data payload 1748. The decryption algorithm 1746 comprises the counterpart to the encryption algorithm 1734. For example, if the encryption algorithm 1734 comprises a symmetric-key cryptographic algorithm, such as AES in encryption mode, for example, then the decryption algorithm 1746 comprises the same AES symmetric-key cryptographic algorithm in decryption mode.

In one embodiment, more than one cryptographic key 1712 or 1728 is used to encrypt different messages transmitted over Communication Medium 1. The order of use of the keys 1712, 1728 comprises one or more of sequential (for example, alternating between Key 1 and Key 2, or any number of keys), a function of time, packet number, or information contained in the packet header and/or trailer, or the like. This enhances security as different keys are used to encrypt different packets transmitted via Communication Medium 1 between Device 1 and Device 2.

In another embodiment, more than one cryptographic key 1712 or 1728 is used to encrypt different messages transmitted over Communication Medium 1. The order of use of the keys 1712, 1728 is signaled to Device 1-Device n using Communication Medium 2 comprising one or more FM broadcast signals.

In one embodiment, cryptographic key 1712 is only valid within a certain geographic area and when any of Device 2-Device n moves outside a geographic area, a new symmetric key is issued to Device 1 and any of Device 2-Device n that moved outside the geographic area. In some embodiments, a GPS sensor is embedded in Device 2-Device n to determine its geographic location.

In other embodiments, Device 2-Device n use Communication Medium 2 to receive the Symmetric key used for secure transmission. As any of Device 2-Device n (portable or mobile receiving device) move in and out of the boundaries of an FM broadcast station; it receives the key broadcast by the FM broadcast station serving its region.

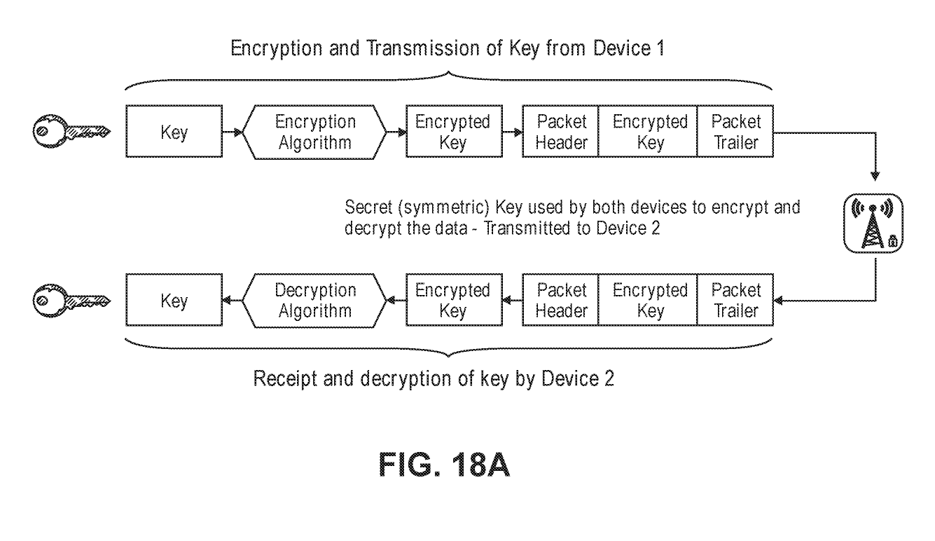

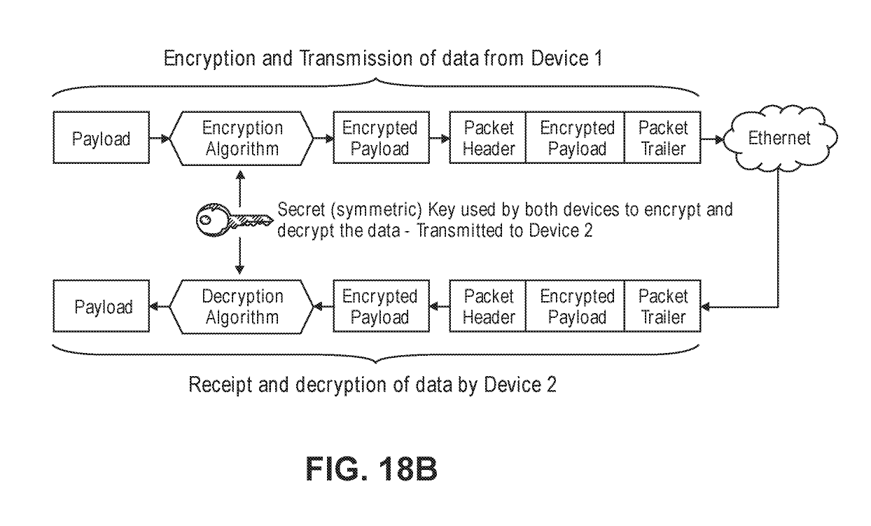

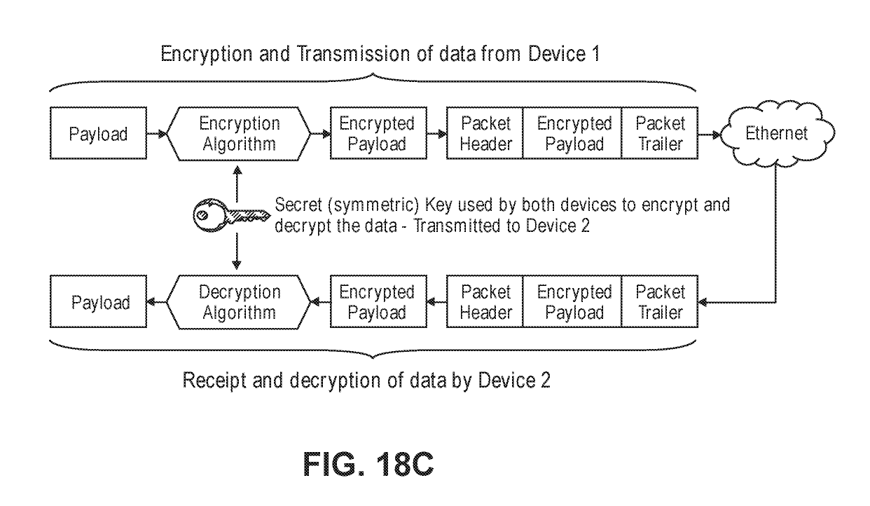

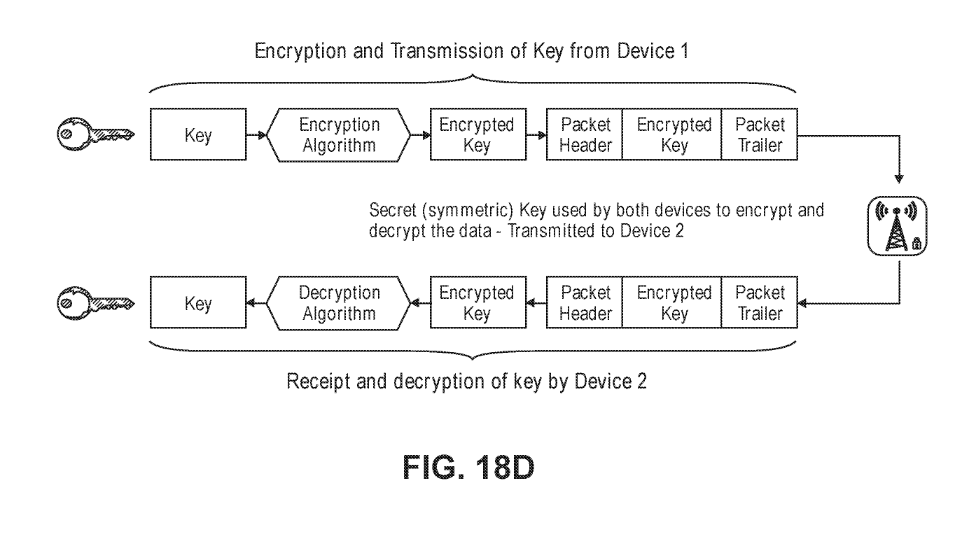

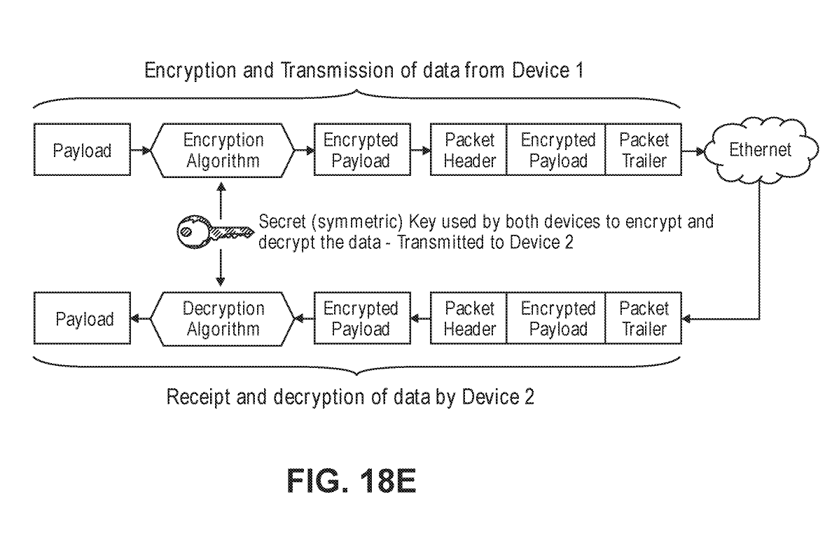

FIGS. 18A-18E illustrate an exemplary key revocation/renewal flow. The cryptographic key 1712 or 1728 can have an expiration, where the expiration is based at least in part on one or more of an expiry date or time, a location of the device, after transmission of one or more packets from Device 1 to Device 2, a transmission of a revocation command, an issuance of a new key, or some other condition.

In FIG. 18A, Device 1 sends a first cryptographic key to Device 2 through Communication Medium 2. This transmission can be according to FIG. 17B described above. From FIG. 18B to FIG. 18C, Device 1 transmits a plurality of data messages, encrypted using the first cryptographic key, to Device 2 through Communication Medium 1. These transmissions can be according to FIG. 17C described above.

In FIG. 18D, Device 1 sends a second cryptographic key to Device 2 through Communication Medium 2. This transmission can be according to FIG. 17B described above. This transmission occurs before the expiration or revocation of the first cryptographic key (for example, the second cryptographic key is to be activated at some future time after it is received at Device 2), around the time of the expiration or revocation of the first cryptographic key (for example, transmission of a second cryptographic key can indicate the expiration or revocation of the first cryptographic key), or after the expiration or revocation of the first cryptographic key (for example, before Device 1 transmits a first data message after the expiration or revocation of the first cryptographic key).

In FIG. 18E, Device 1 transmits one or more data messages, encrypted using the second cryptographic key, to Device 2 through Communication Medium 1. The process may repeat through the transmission/reception of additional cryptographic keys.

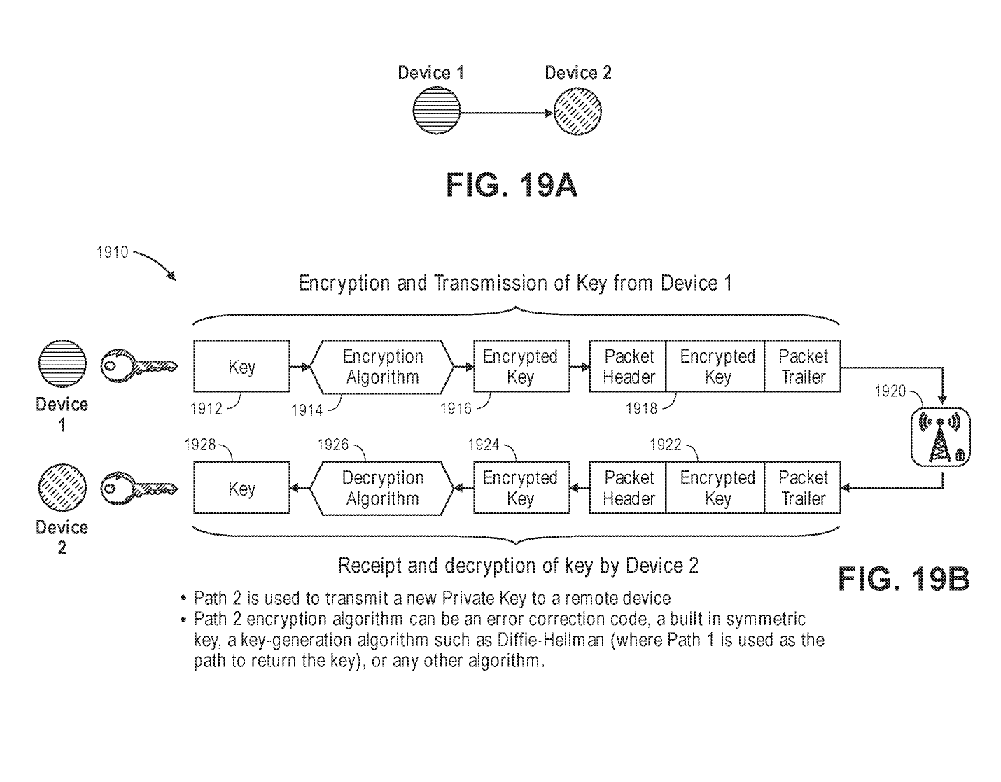

FIGS. 19-21 illustrate embodiments of encrypted transmission of messages using asymmetric-key algorithms, such as RSA, Elliptical Curve (EC) algorithm, and the like.

FIG. 19A shows a system-level private-key-distribution hierarchy, where Device 1 distributes private key to Device 2. Device 2 comprises devices, such as but not limited to IoT devices, energy devices, distributed energy resources, and the like. In an embodiment, Device 1 comprises a controller such as a device in the cloud energy management system 302, which issues commands to Device 2. In another embodiment, Device 1 comprises a Certificate Authority or any other form of Authority that issues private and or public keys.

FIG. 19B illustrates an embodiment of private key distribution flow 1910 from Device 1 to Device 2. The private key is transmitted over Communication Medium 2. In the embodiment illustrated in FIG. 19B, Communication Medium 2 comprises FM broadcast communications using one or more FM subcarriers.

In flow 1910, Device 1 generates a cryptographic key pair comprising a private key 1912 and a public key 2012. The private key 1912 is encrypted or scrambled through an encryption algorithm 1914, resulting in an encrypted or scrambled key pair 1916. The encryption algorithm 1914 can comprise an error correction code, a cryptographic algorithm using a built-in key shared between Device 1 and Device 2, keys exchanged between Device 1 and Device 2 via a key-exchange algorithm such as Diffie-Hellman, and the like. In an embodiment, Device 1 and Device 2 share a plurality of built-in keys and choose one of the plurality of keys to use for a particular key distribution transmission based on a key selection scheme. The key selection scheme can be based on one or more of geographic, temporal, and frequency diversity, for example. If a key-exchange algorithm, such as Diffie-Hellman is used as the cryptographic key of encryption algorithm 1914, then the key exchange can take place, at least in part, through Communication Medium 1.

Device 1 assembles a message 1918 comprising a header, the encrypted private key 1916, and a trailer. Device 1 transmits the message 1918 over Communication Medium 2, shown as 1920 in FIG. 19B. Device 2 receives a message 1922. In the absence of transmission or reception error, the message 1922 comprises the same information as the message 1918. The trailer in the message may or may not contain information known to Device 2 prior to Device 2 receiving the message 1922. For example, the trailer may contain padding to pad the message to a certain length, or the trailer may contain information for some function in the system, such as but not limited to a housekeeping function.

Device 2 extracts encrypted key 1924 from the received message 1922. Device 2 decrypts the key using decryption algorithm 1926, resulting in decrypted or clear-text key 1928. The decryption algorithm 1926 comprises the counterpart to the encryption algorithm 1914. For example, if the encryption algorithm 1914 comprises applying an error correction code by adding parity bits to information bits, then the decryption algorithm comprises applying error correction though the use of both information bits and parity bits. In another example, if the encryption algorithm 1914 comprises a symmetric-key cryptographic algorithm such as AES in encryption mode, then the decryption algorithm 1916 comprises the AES symmetric-key cryptographic algorithm in decryption mode.

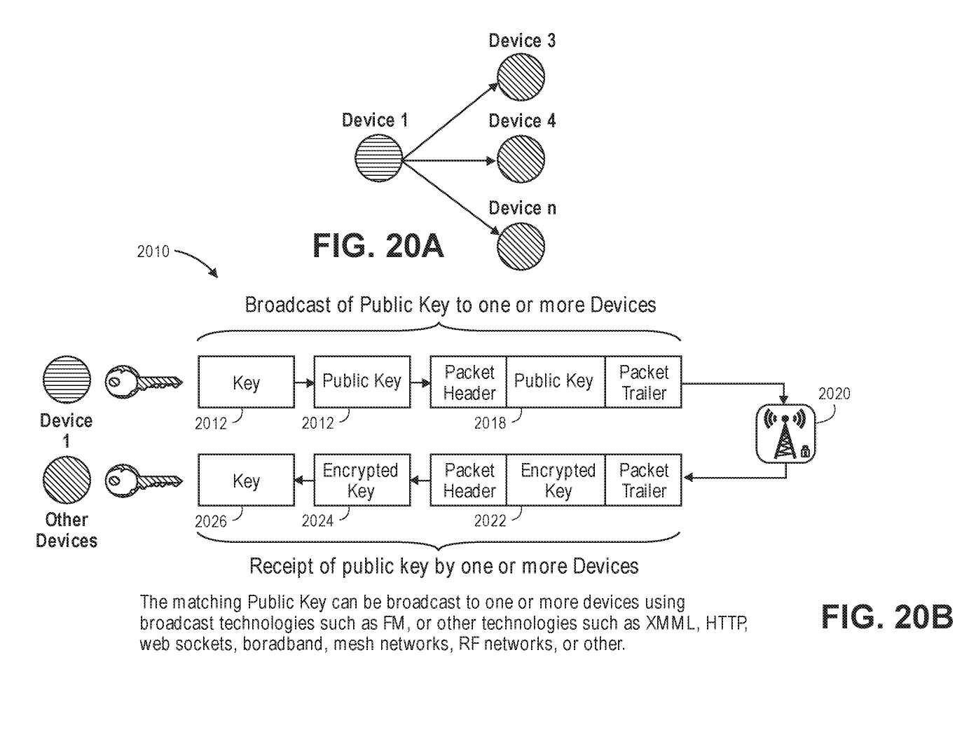

FIG. 20A illustrates a system-level public-key-distribution hierarchy. Device 1 distributes public key 2012 to Device 3-Device n matching the private key 1912 distributed to Device 2. Device 3-Device n comprise devices, such as but not limited to IoT devices, energy devices, distributed energy resources, and the like. Device 1 comprises a controller such as a device in a cloud energy management system 302, which issues commands to Device 3-Device n. In another embodiment, Device 1 comprises a Certificate Authority or any other form of Authority that issues private and or public keys.

FIG. 20B illustrates an embodiment of public key distribution flow 2010 from Device 1 to any of Device 3-Device n. The public key distribution is transmitted over Communication Medium 2. In the embodiment illustrated in FIG. 20B, Communication Medium 2 comprises FM broadcast communications, such as one or more FM subcarriers. In other embodiments, Communication Medium 2 comprises another communication protocol, network, or medium such as XMML, HTTP, web sockets, broadband, mesh networks, RF networks, or the like. In flow 2010, Device 1 generates a cryptographic key pair, comprising a private key 1912 and a public key 2016. Since a public key 2016 can be shared openly, it is not protected via encryption during its transmission.

Device 1 assembles a message 2018 comprising a header, the public key 2016, and a trailer. Device 1 transmits the message 2018 over Communication Medium 2, shown as 2020 in FIG. 20B. Device 2 receives a message 2022. In the absence of transmission or reception error, the message 2022 comprises the same information as the message 2018. The trailer in the message may or may not contain information known to Device 2 prior to Device 2 receiving the message 2022. For example, the trailer may contain padding to pad the message to a certain length, or the trailer may contain information for some function in the system, such as, but not limited to a housekeeping function. Device 2 extracts the public key 2024 from the received message 2022 to provide key 2028, corresponding to the public key 2024.

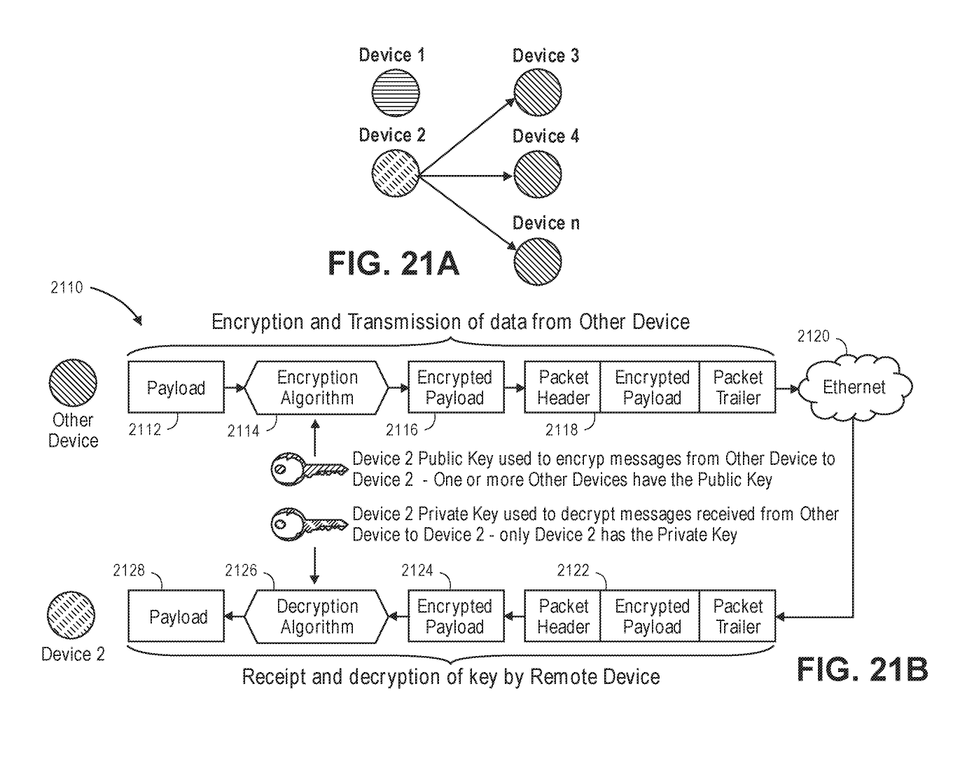

FIG. 21A illustrates an exemplary communications hierarchy among Device 2-Device n, protected by asymmetric-key algorithm. One or more of Device 3-Device n sends a message to Device 2. Device 2-Device n comprise devices, such as but not limited to IoT devices, energy devices, distributed energy resources, and the like.

After Device 2 receives the key 1928 and one or more of Device 3-Device n receives the public key 2028, the one or more of Device 3 to Device n use the public key 2028 to encrypt data communications transmitted to Device 2 through Communication Medium 1. FIG. 21B illustrates an embodiment of a communications flow 2010 protected by an asymmetric-key algorithm between Device 2 and Device 3. In flow 2110, to transmit a data payload 2112, Device 3 applies an asymmetric-key encryption algorithm 2114 using public key 2028 to generate an encrypted data payload 2116. Device 3 assembles a message 2118 comprising a header, the encrypted data payload 2116, and a trailer. Device 3 transmits the message 2118 through Communication Medium 1, shown as 2120 in FIG. 17C. In an embodiment, Communication Medium 1 comprises one or more of Ethernet® communication protocols, cellular broadband communications, 2-way RF networks, and the like.

Device 2 receives a message 2122. In the absence of transmission or reception error, the message 2112 comprises the same information as the message 2118. The trailer in the message may or may not contain information known to Device 2 prior to Device 2 receiving the message 2122. For example, the trailer may contain padding to pad the message to a certain length, or the trailer may contain information for some function in the system which need not be protected by encryption. Device 2 extracts encrypted payload 2124 from the received message 2122. Device 2 decrypts the key using decryption algorithm 2126 and private key 1928, resulting in decrypted or clear-text data payload 2128. The decryption algorithm 2126 comprises the counterpart to the encryption algorithm 2114. For example, if the encryption algorithm 2114 comprises an asymmetric-key cryptographic algorithm, such as, but not limited to RSA in encryption mode, then the decryption algorithm 2126 comprises the RSA asymmetric-key cryptographic algorithm in decryption mode.

As described in connection with FIG. 17B above, in one embodiment, more than one cryptographic key pair 1912 comprising the public key 2016 can be used to encrypt different messages transmitted through Communication Medium 1.

As described in connection with FIGS. 18A through 18E above, in one embodiment, the cryptographic key pair comprising the private key 1912 and public key 2016 expire based at least in part on one or more of an expiry date or time, location of the device, after a one or more packets are transmitted to Device 2, transmission of a revocation command, issuance of a new key, movement of Device 2 outside a geographic region, movement of Device 3-Device n outside a geographic region, or upon some other condition. To replace a key pair, the flow illustrated in FIGS. 19A through 20B can be repeated to distribute a second private key to Device 2, and to distribute a second corresponding public key to Device 3 through Device n.

In the emerging world of the IoT (Internet of Things) are hundreds of thousands and millions of devices which are expected to communicate with each other. Security will be vital for all devices that present a security vulnerability to a nation, entity, organization, corporation, individual, structure, device, or process. Embodiments disclosed herein enhance the security of communications among such devices. The role of and processes used by a Certificate Authority will also need to change to accommodate the large number of Devices that will need to communicate with each other in a trusted manner.

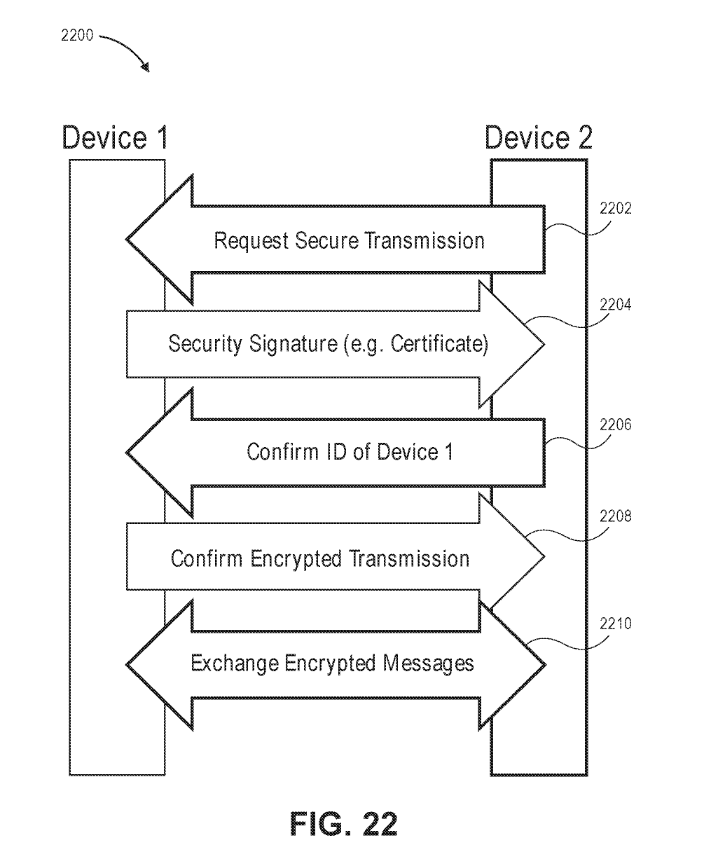

FIG. 22 shows an exemplary communication sequence 3100 between Device 1 and Device 2. This exemplary communication sequence occurs via communication protocol 1 through Communication Medium 1 after the cryptographic keys have been exchanged, directly or indirectly, between Device 1 and Device 2 via communication protocol 2 through Communication Medium 2. Device 1 and Device 2 comprise peripheral devices, such as, but not limited to display devices and/or energy load device control 108, IoT devices, DER devices, and the like. In an embodiment, one of Device 1 and Device 2 comprises a controller such as a device in a cloud energy management system 302, which issues commands to other devices. In another embodiment, Device 1 and Device 2 can be a distributed energy resources or any another IoT device.

At step 2202, Device 2 initiates the exemplary communication sequence by sending a request for secure communications to Device 1. This request signals the need for encrypted communications and initiates handshake necessary for such encrypted communications. At step 2204, Device 1 can respond by sending, for example, a digital certificate to Device 2. Device 1 can generate a signature for the certificate using a cryptographic algorithm, for example, RSA algorithm or digital signature algorithm (DSA). Device 2 can authenticate the certificate using the signature, for example, through the use of a public key associated with Device 1. If Device 2 successfully authenticates the certificate, at step 2206 it confirms to Device 1 that Device 1 ID has been validated.

At step 2208, Device 1 sends a confirmation for encrypted communications. At step 2210, Device 1 and Device 2 exchange encrypted messages. A message may be encrypted using a symmetric-key algorithm, in which case both devices share the same key for encryption and decryption. Alternatively, a message may be encrypted using an asymmetric-key algorithm, in which case the transmitting device uses the public key associated with the receiving device to encrypt the message, and the receiving device uses its associated private key to decrypt the message. The encryption/decryption algorithm at step 2210 may be the same or different from the cryptographic algorithm used to generate/authenticate a signature at step 2204.

Digital Certificates are issued by third parties and used to certify to the public the ownership of a public key. For example, if communicating with www.bank.com, then the www.bank.com website will supply at initiation of a session a digital certificate issued by a trusted party (e.g. Symantec®, GoDaddy®), which includes a public key, to the customer's browser that certifies that the server site is owned by the same entity that owns the email @bank.com, leading the client's browser to trust the site and use the public key to send confidential information. If the certificate can be falsified then, an impostor will impersonate the site www.bank.com and when a client contacts the site, the impostor will provide the false certificate and the client will use the public key in the certificate to encrypt confidential information. The confidential information is decrypted by the impostor resulting in the theft of confidential information, including the client's bank account username and password. The impostor can then contact the real bank site and impersonate the client, gaining full access to the client's bank account. In communication between a client (such as an internet user) and a server (such as a bank's website) there have been cases where fraudulent certificates have been issued, leading an entity to impersonate a trusted server.

It is important to trust the Certificate Authority issuing the digital certificate. Browsers come with a large built in list of root certificates and recognized Certificate Authorities (CA). Root certificates are distributed in Internet Browsers by the manufacturer or by the OS developer. This poses a challenge in that some of these Certificate Authorities can cease to exist or be compromised.

In one embodiment, FM broadcast technology is used by the issuing CA to confirm the validity of a digital certificate. When Device 3 (client) requests a digital certificate from Device 2 (a server), the server sends the certificate. Device 3 then informs the corresponding Certificate Authority, Device 1, of the received certificate and the information in the certificate. The Certificate Authority uses the FM broadcast technology to send a message confirming or denying the authenticity of the certificate.

In another embodiment, the Certificate Authority (Device 1) sends the hash of a key to Device 3 via Communication Medium 2 or Communication Path 2. Device 3 compares the hash received via Communication Medium 2 or Communication Path 2 with the hash of a key included in the digital certificate received via Communication Medium 1 or Communication Path 1 to validate the authenticity of the public certificate.

In another embodiment, the Certificate Authority (Device 1) uses Communication Medium 2 or Communication Path 2 to send instructions, code and or security keys to Device 2-Device n where Device 2-Device n use Communication Medium 1 or Communication Path 1 to send confirmation, messages, instructions, code and security keys back to the Certificate Authority.

In another embodiment, the Device Manufacturer uses Communication Medium 2 or Communication Path 2, for example FM broadcast, to issue an updated list of trusted Certificate Authorities to its Devices in the field, or to remove a specific Certificate Authority from the list of trusted CAs (root certificates).

### TERMINOLOGY

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an ASIC, a FPGA or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC.

The above detailed description of certain embodiments is not intended to be exhaustive or to limit the invention to the precise form disclosed above. While specific embodiments of, and examples for, the invention are described above for illustrative purposes, various equivalent modifications are possible within the scope of the invention, as those ordinary skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “proportional to”, as generally used herein refer to being based at least in part on. The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The teachings of the invention provided herein can be applied to other systems, not necessarily the systems described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A device to communicate encrypted messages over a first communication medium, the device comprising:
a receiver configured to receive a first portion of an encryption key transmitted within a first wideband digital subcarrier operating within a licensed frequency spectral mask of a terrestrial wireless VHF FM Broadcast radio station, the receiver further configured to receive a second portion of the encryption key transmitted within a second wideband digital subcarrier operating within the licensed frequency spectral mask of the terrestrial wireless VHF FM Broadcast radio station;
a control module configured to use the first and second portions to form the encryption key; and
a communication port configured to receive a message over the first communication medium, wherein the received message was encrypted using the encryption key;
the control module further configured to decrypt the received message using the encryption key, create a response based at least in part on the decrypted message, and encrypt the response using the encryption key;
the communication port further configured to transmit the encrypted response over the first communication medium;
wherein the first communication medium is different from the first and second wideband digital subcarriers operating within the licensed frequency spectral mask of the terrestrial wireless VHF FM Broadcast radio station.

2. The device of claim 1 wherein the receiver is further configured to receive a third portion of the encryption key transmitted within a third wideband digital subcarrier operating within the licensed frequency spectral mask of the terrestrial wireless VHF FM Broadcast radio station.

3. The device of claim 2 wherein the control module is further configured to use at least two of the first, second, and third portions to form the encryption key.

4. The device of claim 1 wherein the first communication medium comprises one or more of a wired networking protocol, a wireless networking protocol, cellular communications, the Internet, a local area network, and a wide area network.

5. The device of claim 1 wherein each of the first and second wideband digital subcarriers of the licensed terrestrial wireless VHF FM Broadcast radio station has a data throughput of at least 12 kilobits per second.

6. The device of claim 1 wherein the encryption key is updated once a minute.

7. The device of claim 6 wherein updating the encryption key comprises varying a ratio of the first portion of the encryption key to the second portion of the encryption key.

8. The device of claim 1 wherein the encryption key is allocated by one or more of type of apparatus, region, time of day, alert priority level, originator, message type, customer identification, location data, grid location data, tariffs affected, apparatus class, and apparatus subclass.

9. The device of claim 1 wherein the decrypted message comprises a command to change an energy consumption that includes changing one or more of an energy source, an amount of energy consumed, an operational point, an operational schedule, and an operational parameter.

10. The device of claim 9 further comprising a motor, wherein the control module is further configured to send control signals to the motor to change the energy consumption of the motor, and wherein the encrypted response comprises encrypted data associated with the change in the energy consumption of the motor.

11. A method to communicate encrypted messages over a first communication medium, the method comprising:
receiving a first portion of an encryption key transmitted within a first wideband digital subcarrier operating within a licensed frequency spectral mask of a terrestrial wireless VHF FM Broadcast radio station;
receiving a second portion of the encryption key transmitted within a second wideband digital subcarrier operating within the licensed frequency spectral mask of the terrestrial wireless VHF FM Broadcast radio station;
using the first and second portions to form the encryption key;
receiving a message over the first communication medium, wherein the received message was encrypted using the encryption key;
decrypting the received message using the encryption key;
creating a response based at least in part on the decrypted message;
encrypting the response using the encryption key; and
transmitting the encrypted response over the first communication medium;
wherein the first communication medium is different from the first and second wideband digital subcarriers operating within the licensed frequency spectral mask of the terrestrial wireless VHF FM Broadcast radio station.

12. The method of claim 11 further comprising receiving a third portion of the encryption key transmitted within a third wideband digital subcarrier operating within the licensed frequency spectral mask of the terrestrial wireless VHF FM Broadcast radio station.

13. The method of claim 12 further comprising using at least two of the first, second, and third portions to form the encryption key.

14. The method of claim 11 wherein the first communication medium comprises one or more of a wired networking protocol, a wireless networking protocol, cellular communications, the Internet, a local area network, and a wide area network.

15. The method of claim 11 wherein each of the first and second wideband digital subcarriers of the licensed terrestrial wireless VHF FM Broadcast radio station has a data throughput of at least 12 kilobits per second.

16. The method of claim 11 further comprising updating the encryption key once a minute.

17. The method of claim 16 wherein updating the encryption key comprises varying a ratio of the first portion of the encryption key to the second portion of the encryption key.

18. The method of claim 11 wherein the encryption key is allocated by one or more of type of apparatus, region, time of day, alert priority level, originator, message type, customer identification, location data, grid location data, tariffs affected, apparatus class, and apparatus subclass.

19. The method of claim 11 further comprising changing an energy consumption based at least in part on the decrypted message, wherein changing the energy consumption comprises changing one or more of an energy source, an amount of energy consumed, an operational point, an operational schedule, and an operational parameter.

20. The method of claim 19 further comprising sending control signals to a device to change the energy consumption of the device, wherein the encrypted response comprises encrypted data associated with the change in the energy consumption of the device.
